(19) United States
(12) Patent Application Publication
(10) Pub. No.: US 2026/0084452 A1
(43) Pub. Date: Mar. 26, 2026

(54) IMAGE FORMING APPARATUS

(71) Applicant: CANON KABUSHIKI KAISHA, Tokyo (JP)

(72) Inventors: HIROYUKI TAKAHASHI, Chiba (JP); TOSHIYUKI KUROSU, Ibaraki (JP); SHINYA KITAGO, Chiba (JP); RYOICHI KAWASUMI, Ibaraki (JP)

(21) Appl. No.: 19/283,888

(22) Filed: Jul. 29, 2025

(30) Foreign Application Priority Data
Sep. 26, 2024 (JP) 2024-167006
Apr. 18, 2025 (JP) 2025-068691

(51) Int. Cl. B41J 29/13; B41J 29/02

(52) U.S. Cl. CPC B41J 29/13; B41J 29/02

(57) ABSTRACT

An image forming apparatus includes: a door 100 disposed on a front side of an image forming portion in a front-back direction intersecting a vertical direction, and attached to a main body frame to form at least part of a front exterior; and a hinge 140 connecting the door 100 and the main body frame 200 such that the door 100 rotates to be opened and closed with respect to the main body frame 200, in which adjustment holes 166 and 167 are provided in the door 100 and the hinge 140, respectively, and the adjustment hole 167 of the door 100 and the adjustment hole 166 of the hinge 140 are arranged to at least partially overlap each other.

### BACKGROUND

Field of the Technology The present disclosure relates to an image forming apparatus that forms an image, such as a printing machine, a copying machine, or a printer.

### Description of the Related Art

In the industrial printing industry, it is desirable for an operator to be able to visually check an operating state of an image forming apparatus. For a large-scale ink jet printer, there is provided an image forming apparatus in which a scanning state of an ink ejection head can be seen. Similarly, for a label printer, an image forming apparatus in which an operating state is visible is also available on the market.

In such an image forming apparatus, the height of the main body of the apparatus is generally lower than a person's height. As a configuration in which an operating state can be visually observed in such an image forming apparatus, there is a configuration in which a recording portion of the image forming apparatus is not covered with an exterior cover. Alternatively, there is a configuration in which an exterior cover is provided on a front surface of the image forming apparatus and a transparent window is partially disposed in the exterior cover. In addition, there is a configuration in which illumination is provided inside the image forming apparatus to improve visibility (Japanese Patent Application Laid-Open No. 2016-215522).

However, the door is required to have not only the function of the transparent window but also functions of an engagement unit (latch) that maintains the door in a closed state, a detection unit that detects the door in the closed state, and a sealing unit that isolates the inside and the outside of the apparatus from each other. Therefore, it is necessary to adjust the position of the door with respect to the inside of the apparatus with high accuracy. In particular, many of the doors of the large-scale image forming apparatuses are made of parts formed of metal such as sheet metal and are heavy.

Therefore, when position adjustment is performed during assembly, installation, or service maintenance in a factory, a plurality of persons are required to work together, posing a problem of poor workability.

### SUMMARY

One aspect of the present disclosure provides an image forming apparatus including: an image forming portion configured to form an image on a sheet; a main body frame supporting the image forming portion; a door disposed on a front side of the image forming portion in a front-back direction intersecting a vertical direction, and attached to the main body frame to form at least part of a front exterior; and a hinge connecting the door and the main body frame such that the door rotates to be opened and closed with respect to the main body frame, in which an adjustment hole is provided in each of the door and the hinge, and the adjustment hole of the door and the adjustment hole of the hinge are arranged to at least partially overlap each other.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view illustrating a schematic configuration of an image forming apparatus;

FIG. 2 is a schematic cross-sectional view of a printing module;

FIG. 3 is a schematic view of the printing module in a state where a front door is opened as viewed from a front side;

FIG. 4 is a perspective view of a printing belt unit.

FIG. 5 is a perspective view of a recording head as viewed from an ink ejection surface direction.

FIG. 6 is a perspective view illustrating a retracted position of the recording head.

FIG. 7 is a perspective view illustrating a printing position of the recording head.

FIGS. 8A and 8B are views for explaining a movement of the recording head to the printing position.

FIGS. 9A and 9B are views for explaining a movement of the recording head to the printing position.

FIGS. 10A and 10B are views for explaining a movement of the recording head to the printing position.

FIG. 11 is a perspective view illustrating a state of the recording head before being attached to a head holder.

FIGS. 12A and 12B are perspective views illustrating a movement operation of the scanner unit.

FIGS. 13A and 13B are perspective views illustrating a movement operation of the scanner unit.

FIG. 14 is a schematic perspective view illustrating a state in which a recording portion and a maintenance portion are mounted on a main body frame of the printing module.

FIG. 15 is a schematic view of the main body frame of the printing module as viewed from directly above.

FIG. 16 is a left cross-sectional view of the printing module.

FIG. 17 is a cross-sectional view of the printing module taken along line G-G of FIG. 16.

FIGS. 18A and 18B are overall schematic views of the front door of the printing module.

FIG. 19 is a structural exploded view of the front door of the printing module.

FIGS. 20A and 20B are views in which the front door of the printing module is opened upward.

FIG. 21 is a view for explaining a hanging string of the front door opened upward.

FIG. 22 is a perspective view illustrating an upper hinge.

FIG. 23 is a perspective view illustrating the front door and the upper hinge.

FIG. 24 is a perspective view illustrating the main body frame and the upper hinge.

FIG. 25 is a perspective view illustrating the upper hinge.

FIGS. 26A and 26B are views illustrating the upper hinge.

FIG. 27 is a perspective view illustrating the upper hinge.

FIG. 28 is an exploded perspective view of a position adjustment mechanism of the front door.

FIGS. 29A, 29B, and 29C are perspective views of the position adjustment mechanism of the front door.

FIGS. 30A, 30B, and 30C are cross-sectional views of the position adjustment mechanism illustrated in FIGS. 29A to 29C.

FIGS. 31A, 31B, and 31C are front views of the hinge illustrated in FIGS. 29A to 29C.

FIG. 32 is an exploded perspective view of a position adjustment mechanism of a front door according to another embodiment.

FIGS. 33A, 33B, and 33C are perspective views of the position adjustment mechanism of the front door according to another embodiment.

FIGS. 34A, 34B, and 34C are cross-sectional views of the position adjustment mechanism illustrated in FIGS. 33A to 33C.

FIGS. 35A, 35B, and 35C are front views of the hinge illustrated in FIGS. 33A to 33C.

FIG. 36 is an exploded perspective view of a position adjustment mechanism of a front door according to another embodiment.

FIG. 37 is a perspective view of the position adjustment mechanism of the front door according to another embodiment.

FIG. 38 is a front view of the position adjustment mechanism according to another embodiment.

FIG. 39 is a cross-sectional view of the position adjustment mechanism illustrated in FIG. 38.

FIG. 40 is a view illustrating a component force applied to the position adjustment mechanism illustrated in FIG. 38.

### DESCRIPTION OF THE EMBODIMENTS

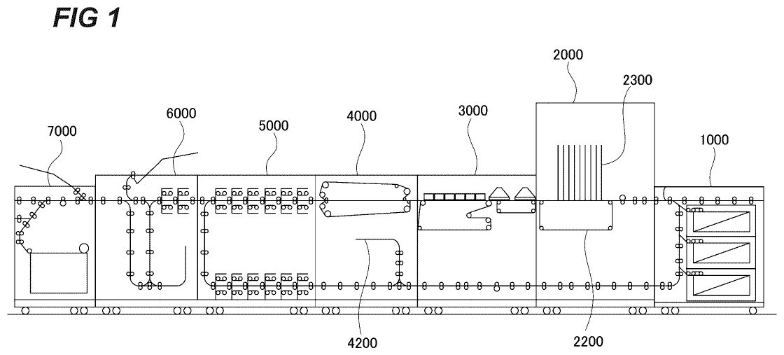

Hereinafter, an embodiment of an image forming apparatus according to the present disclosure will be specifically described with reference to the drawings. Note that dimensions, materials, relative positions, and the like of components of the image forming apparatus described below do not limit the scope of the present disclosure unless otherwise specified. In addition, the same reference numerals in the drawings denote the same configurations or functions, and redundant description thereof will be appropriately omitted.

<Image Forming Apparatus>A schematic configuration of an image forming apparatus will be described with reference to FIG. 1. FIG. 1 is a schematic view illustrating a configuration of an image forming apparatus. The image forming apparatus illustrated in FIG. 1 is an example of an inkjet image forming apparatus that forms an image using an inkjet method.

The image forming apparatus processes paper (recording medium) fed from a sheet feeding module 1000 through a printing module 2000, a drying module 3000, a fixing module 4000, a cooling module 5000, an inverting module 6000, and a discharged sheet stacking module 7000 in this order. An image is formed on the paper fed from the sheet feeding module 1000 by the printing module 2000. The drying module 3000 is a unit that reduces an amount of liquid contained in ink to improve fixability between the paper and the ink, and the fixing module 4000 heats the paper to soften the applied ink. The cooling module 5000 cools the fixed paper to solidify the softened ink, and suppresses a change in paper temperature at a position downstream of the cooling module. The inverting module 6000 adjusts the orientation of the paper to a desired orientation. The discharged sheet stacking module 7000 aligns and stacks the printed paper.

At the time of duplex printing, the paper is U-turned in the cooling module 5000 and conveyed toward the printing module, and the front and back sides and the front and back directions of the paper are changed by an inverting device 4200 provided in the fixing module 4000. Thereafter, the paper is conveyed back to the printing module 2000 through the drying module 3000 and a duplex conveying path of the sheet feeding module 1000 to perform printing on the back side.

In this manner, the image forming apparatus includes the printing module 2000 serving as a first module including a recording portion 2300 and a printing belt unit 2200. The image forming apparatus further includes a second module (1000, 3000, 4000, 5000, 6000, and/or 7000) that is connected adjacent to one or both of the left and right sides in the left-right direction of the printing module 2000 and has a function different from that of the printing module 2000. The left-right direction in the present embodiment is a direction in which a sheet is conveyed when an image is formed. The direction in which the sheet is conveyed may be referred to as a first direction. That is, in the present embodiment, the first direction refers to the left-right direction. In this embodiment, the right side in the left-right direction corresponds to an upstream side in the conveyance direction, and the left side in the left-right direction corresponds to a downstream side in the conveyance direction.

Here, although it has been exemplified that the image forming apparatus is formed by connecting modules having different functions to both sides of the printing module 2000 in the left-right direction has been exemplified, the configuration is not limited thereto. The image forming apparatus may be formed by connecting modules having different functions to the left side of the printing module 2000 in the left-right direction. Alternatively, the image forming apparatus may be formed by connecting modules having different functions to the right side of the printing module 2000 in the left-right direction.

### Printing Module

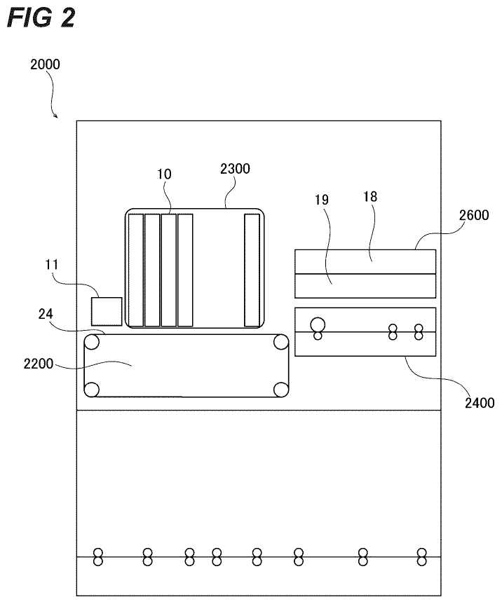

A configuration of the printing module 2000 will be described with reference to FIG. 2. FIG. 2 is a schematic cross-sectional view of the printing module 2000.

The printing module 2000 is an image forming portion that performs recording processing on paper (recording medium) as a conveyed sheet from above the paper using a recording head 10 to form an image on the paper. The printing module 2000 includes a pre-image formation registration correction portion 2400, a printing belt unit 2200 serving as a conveying portion, a recording portion 2300, a maintenance portion 2600, and a scanner unit 11. The paper is conveyed in a sucked state by the printing belt unit 2200, thereby securing a clearance from the recording head.

The paper conveyed from the sheet feeding module 1000 is conveyed to the printing belt unit 2200 after the inclination and position of the paper are corrected by the pre-image formation registration correction portion 2400. The recording portion 2300 is disposed at a position facing the printing belt unit 2200 with respect to the conveyance path. The recording portion 2300 performs recording processing (printing) on paper as a conveyed sheet from above the paper using the recording head 10 to form an image on the paper. For the conveyance of the paper in the recording portion 2300, the printing belt unit 2200 that conveys the paper in a sucked and adsorbed state is disposed so that the paper conveyance behavior is stabilized directly below the recording head 10. In the printing belt unit 2200, the paper conveyed on a paper conveyance surface 24, which is a sheet conveyance surface, is conveyed in a state where a clearance from the recording head 10 is secured. The recording head 10 forms an image by ejecting ink to the conveyed paper at an appropriate ejection timing. A plurality of recording heads 10 is arranged along the conveyance direction. In this example, a total of five line-type recording heads corresponding to four colors, i.e., yellow (Y), magenta (M), cyan (C), and black (Bk), and a reaction liquid are provided.

The scanner unit 11 is installed downstream of the recording head 10 in the conveyance direction. The scanner unit 11 inspects the image immediately after the application of the ink by reading the paper and the image on the paper conveyance surface 24 of the printing belt unit 2200. When an image defect is detected by an ink ejection failure or the like as an ink ejection hole is blocked, the apparatus is immediately stopped to minimize the production of defective products. The scanner unit 11 is a unit (reading portion) that not only detects an ink ejection state but also reads the image formed on the paper by the recording portion during printing, detects a deviation or a density of the image, and corrects the printing.

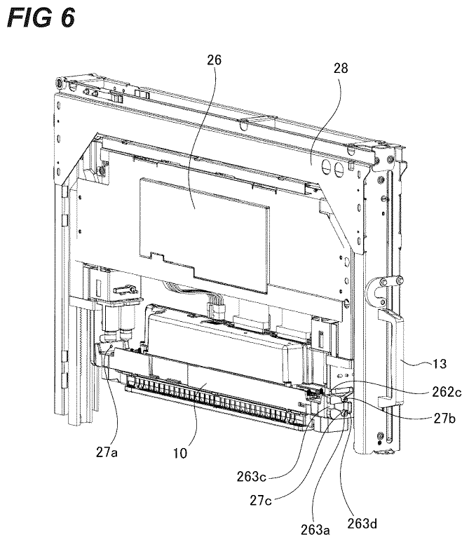

The maintenance portion 2600 is disposed to the right side of the recording portion 2300. The recording head 10 of the recording portion 2300 can be lifted or lowered, and may be moved to a retracted position (see FIG. 6) upward in the vertical direction as necessary. The maintenance portion 2600 moves to a position directly below the recording head 10 located at the retracted position to perform maintenance on the recording portion 2300 (recording head 10).

The maintenance portion 2600 includes a cap tray 18 in which a cap mechanism (not illustrated) for protecting an ink ejection surface of the recording head 10 is disposed. The maintenance portion 2600 includes a cleaning tray 19 in which a cleaning mechanism (not illustrated) for recovering the ejection performance of the recording head 10 is disposed. The maintenance portion 2600 is a unit having a two-layer structure in which the cap tray 18 is provided on an upper level and the cleaning tray 19 is provided on a lower level. Note that the ink ejection surface is an ejection orifice surface (nozzle surface) of the recording head 10 in which a plurality of ejection orifices for ejecting the ink is arranged.

While the operation is stopped, the cap tray 18 is directly below the recording portion 2300, and the recording head 10 is capped by landing on the cap mechanism (not illustrated) in the cap tray to prevent the ink ejection surface of the recording head 10 from being dried. According to a print start command from a controller (not illustrated), the recording head 10 is first lifted to the retracted position and spaced away from the cap tray 18. Next, the cap tray 18 is retracted to its retracted position, and thereafter the recording head 10 is lowered to a printing position to perform a printing operation. According to a print end command, the recording head 10 is lifted to the retracted position. Thereafter, when the cap tray 18 moves from the retracted position to a position directly below the recording portion 2300, the recording head 10 is lowered and capped by landing on the cap tray, and reaches a stop state then.

Even during printing, when a predetermined continuous operating time is reached, a cleaning command is issued from the controller (not illustrated). According to the cleaning command, after the recording head 10 is lifted to the retracted position, the cleaning tray 19 located on the lower level of the maintenance portion 2600 moves to the position directly below the recording portion 2300. Thereafter, the recording head 10 is lowered and lands on the cleaning tray 19, and a cleaning operation such as wiping or vacuuming is performed. After the cleaning is completed, the recording head 10 is lifted to the retracted position, the cleaning tray 19 moves from the position directly below the recording portion 2300 to the retracted position, and the recording head 10 is lowered to the printing position to resume the printing. In a case where the printing is not resumed after the cleaning is completed, the recording head 10 is lifted to the retracted position after the cleaning is completed, the cleaning tray 19 moves from the position directly below the recording portion 2300 to the retracted position, and the cap tray 18 moves from the retracted position to the position directly below the recording portion 2300. Then, the recording head 10 is lowered and capped by landing on the cap tray 18, and reaches a stop state then. The cleaning of the head during the printing operation may be performed after paper circulating in the machine is completely subjected to the printing processing and the supply of new paper is stopped. Alternatively, the cleaning of the head during the printing operation may be performed after being temporarily stopped in a state where paper is circulating.

Note that the number of colors and the number of recording heads in the image forming apparatus are not limited to five. Further, as the inkjet method, a method using a heat generating element, a method using a piezoelectric element, a method using an electrostatic element, a method using an MEMS element, or the like can be adopted.

### Configuration of Recording Portion

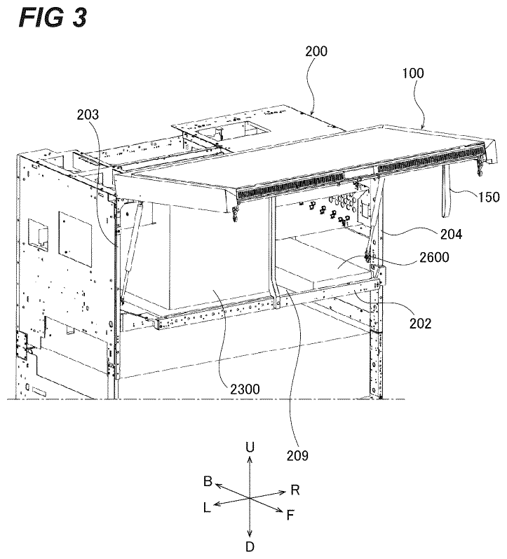

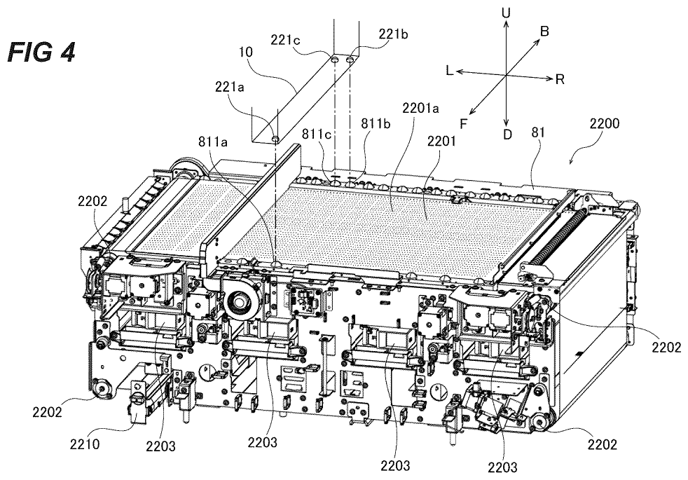

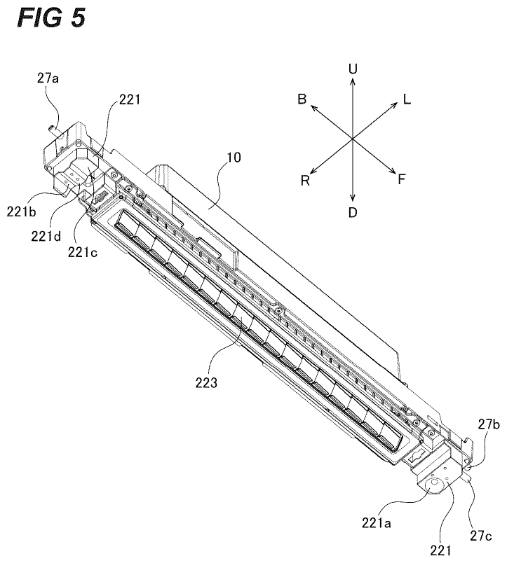

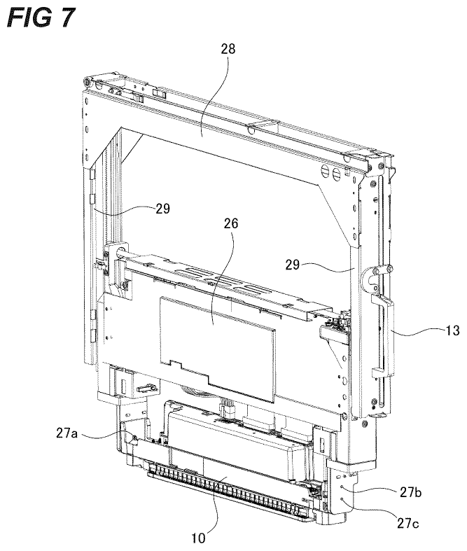

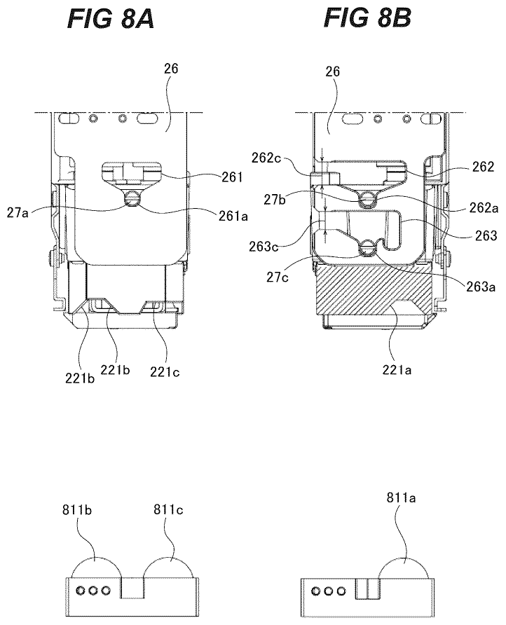

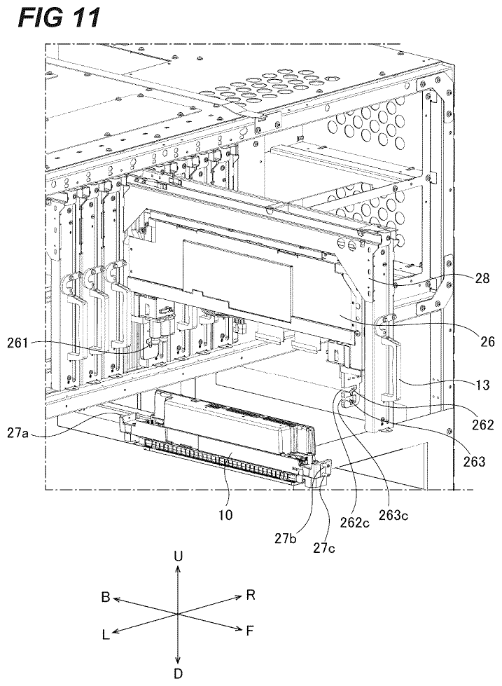

Next, the configurations of the recording portion 2300 and the printing belt unit 2200 in the present embodiment will be described with reference to FIGS. 3 to 11. FIG. 3 is a schematic view of the printing module 2000 as viewed from a front side direction in a state where a front door (exterior cover) covering the recording portion 2300 is opened. FIG. 4 is a perspective view of the printing belt unit 2200. FIG. 5 is a perspective view of the recording head 10 as viewed from an ink ejection surface direction. FIG. 6 is a perspective view illustrating a state in which the recording head 10 is located at the retracted position, and FIG. 7 is a perspective view illustrating a state in which the recording head 10 is located at the printing position. FIGS. 8A to 10B are views for explaining a movement of the recording head 10 to the printing position. FIG. 11 is a perspective view illustrating a state of the recording head before being attached to a head holder.

An upward direction U, a downward direction D, a rightward direction R, a leftward direction L, a backward direction B, and a forward direction F used in the following description are defined as illustrated in FIG. 3. A side of a main body frame 200 (printing module 2000) illustrated in FIG. 3 on which a front door 100 serving as an exterior cover is disposed is defined as a front side (near side or forward side), and the opposite side is defined as a back side (far side or rearward side). When the recording portion 2300 is used as a reference, a side on which the scanner unit 11 (see FIG. 2) is disposed is defined as a left side. When the recording portion 2300 is used as a reference, a side on which the maintenance portion 2600 is disposed is defined as a right side. Furthermore, the upward side in the vertical direction, which is a direction perpendicular to the front-back direction and the left-right direction defined here, is defined as an upward direction, and the downward side in the vertical direction, which is a direction perpendicular to the front-back direction and the left-right direction defined here, is defined as a downward direction. The defined forward direction F, backward direction B, rightward direction R, leftward direction L, upward direction U, and downward direction D are illustrated in FIG. 3. The left-right direction is a direction orthogonal to the vertical direction (up-down direction), and is the same as the conveyance direction in which paper as a sheet is conveyed. The front-back direction is a direction orthogonal to the vertical direction and the left-right direction (first direction).

As illustrated in FIG. 4, the printing belt unit 2200 includes a printing belt 2201, a belt roller 2202, a suction unit 2203, a cleaning unit 2210, etc. The printing belt 2201 serves as a contact surface that comes into contact with paper when the paper is conveyed, and a plurality of suction holes 2201a are provided in the left-right direction and in the front-back direction. The suction holes 2201a are through holes penetrating the printing belt 2201 in a thickness direction, and are provided in a distributed manner on an inner side and an outer side of a region through which the paper passes when the paper is conveyed. The belt roller 2202 keeps the tension of the printing belt 2201 constant. The suction unit 2203 sucks the paper through the suction holes 2201a. The cleaning unit 2210 abuts against the printing belt 2201 and wipes off mist and paper dust adhering to the surface of the printing belt 2201. In the present embodiment, the number of suction units 2203 arranged in the printing belt unit 2200 is four, but the number of suction units 2203 is not limited to four.

The printing belt unit 2200 is disposed immediately below the recording head 10. That is, the printing belt unit 2200 is disposed at a position facing the recording portion 2300 in the vertical direction. The printing belt unit 2200 has a height adjustment function of adjusting the height of the paper conveyance surface (sheet conveyance surface) such that the paper surface has a predetermined clearance from the recording head 10 according to the paper thickness. As described above, the printing belt unit 2200 has a suction-conveying function of conveying paper while keeping the paper flat by following the surface of the conveying belt.

A housing 81 of the printing belt unit 2200 is provided with positioning members 811 for positioning the recording head 10 at the printing position (recording position). Specifically, for one recording head 10, one positioning member 811a is provided on the near side (on the forward side of the apparatus) in the front-back direction (paper width direction) with the printing belt 2201 interposed therebetween, and two positioning members 811b and 811c are provided on the far side (on the rearward side of the apparatus).

As illustrated in FIG. 5, the recording head 10 includes a nozzle plate 223 including a plurality of nozzles for ejecting ink aligned in a longitudinal direction (paper width direction or front-back direction) of the recording head, and abutting portions 221 are provided at both ends of the recording head 10. Specifically, the recording head 10 has a first abutting portion 221a formed by a cone-shaped recess having an inclined surface on the near side in the longitudinal direction, a second abutting portion 221b formed by a V-shaped recess having two flat surfaces on the far side in the longitudinal direction, and a third abutting portion 221c formed by a flat portion. Here, a guide shape 221d is provided in the vicinity of the third abutting portion 221c formed by a flat portion. The guide shape 221d plays a role in solving a problem that, when the third abutting portion 221c and the recording head positioning member 811c abut on each other, the recording head (ink ejection head) 10 is displaced in sliding position, and a ball does not enter the positioning portion, making it impossible to position the recording head FIG. 6 is a schematic perspective view illustrating a state in which the recording head 10 is located at the retracted position retracted upward with respect to the printing belt unit 2200. FIG. 7 is a schematic perspective view illustrating a state in which the recording head 10 is located at the printing position (recording position) where an image is printed on paper. The recording head 10 is detachably attached to a head holder 26. The recording head 10 is automatically lifted or lowered integrally with the head holder 26 by a driving mechanism (not illustrated) between the printing position close to the paper conveyance surface 24 and the retracted position when printing is not performed, along a lifting and lowering rail 29 provided in a recording head lifting and lowering frame 28.

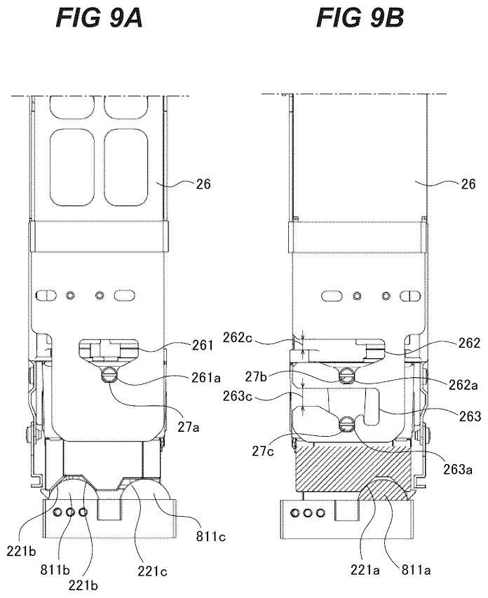

A state in which the recording head 10 moves from the retracted position to the printing position, and engages with the positioning member 811 will be described with reference to FIGS. 8A to 10B. Each of FIGS. 8A, 9A, and 10A is a view of the recording head 10 as viewed from the back side in the front-back direction. Each of FIGS. 8B, 9B, and 10B is a view of the recording head 10 as viewed from the front side in the front-back direction. The recording head 10 (FIGS. 8A and 8B) located at the retracted position is lowered integrally with the head holder 26, and lands on the positioning members 811a to 811c of the printing belt unit 2200 (FIGS. 9A and 9B).

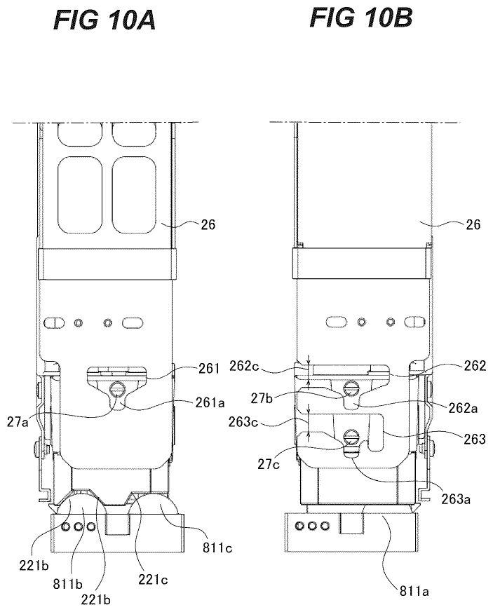

Thereafter, the head holder 26 is further lowered, and the weight of the recording head 10 is applied to the positioning members 811a to 811c, so that the spherical shapes of the positioning members 811a to 811c tightly engage with conical recess shapes of positioning portions 211a to 211c of the recording head 10 (FIGS. 10A and 10B). As a result, the recording head 10 and the printing belt unit 2200 can be positioned with high accuracy. The recording head 10 may be brought into abutment against the positioning members 811a to 811c only by the weight of the recording head 10, or by applying an abutment pressure using another pressurizing unit (not illustrated).

Next, attachment work for setting the recording head 10 in the printing module 2000 will be described with reference to FIG. 11. FIG. 11 is a perspective view illustrating a state before the recording head 10 is attached to the printing module 2000.

As illustrated in FIG. 11, when the recording head 10 is set in the printing module 2000, first, the recording head lifting and lowering frame 28 has been pulled out from the printing module 2000 to the near side in the front-back direction. The recording portion 2300 includes a handle 13 at a front end in the front-back direction of the recording head lifting and lowering frame 28. An operator pulls out the recording head lifting and lowering frame 28 to the near side in the front-back direction from the printing module 2000 using the handle 13. Then, the operator goes around to the left side of the drawn-out recording head lifting and lowering frame 28 and faces the left side surface of the head holder 26 to attach the recording head 10. The recording head 10 is held by the head holder 26 having an automatically lifting and lowering function as described above, and is connected to the head holder 26 by pins or the like to be described later.

When the recording head 10 is attached to the head holder 26, first, a first pin 27a provided on the far side of the recording head 10 is inserted into a first hole 261 of the head holder 26. Thereafter, a second pin 27b and a third pin 27c provided on the near side of the recording head 10 are guided from a second notch 262c and a third notch 263c of the head holder 26 into a second hole 262 and a third hole 263, respectively. Further, the first pin 27a, the second pin 27b, and the third pin 27c are supported by a first groove 261a of the first hole 261, a second groove 262a of the second hole 262, and a third groove 263a of the third hole 263, respectively. By doing so, the recording head 10 can be attached to the head holder 26 in a state where the posture of the recording head 10 with respect to the head holder 26 is determined. At this time, as illustrated in FIG. 11, the first pin 27a and the first hole 261 are arranged on the far side in the paper width direction, and the second pin 27b, the third pin 27c, the second hole 262, and the third hole 263 are arranged on the near side in the paper width direction. Therefore, the first pin 27a only needs to be inserted into the first hole 261 on the far side far from the operator's hand, and the second pin 27b and the third pin 27c are introduced into the second hole 262 and the third hole 263, respectively, on the near side near the operator's hand. As a result, the recording head 10 can be easily set in the head holder 26.

As described above, the printing belt unit 2200 includes the printing belt 2201 serving as a conveying belt that conveys paper in an adsorbed state. The printing belt 2201 has a color (dark color) having a high contrast ratio with paper (sheet).

### Configuration of Reading Portion

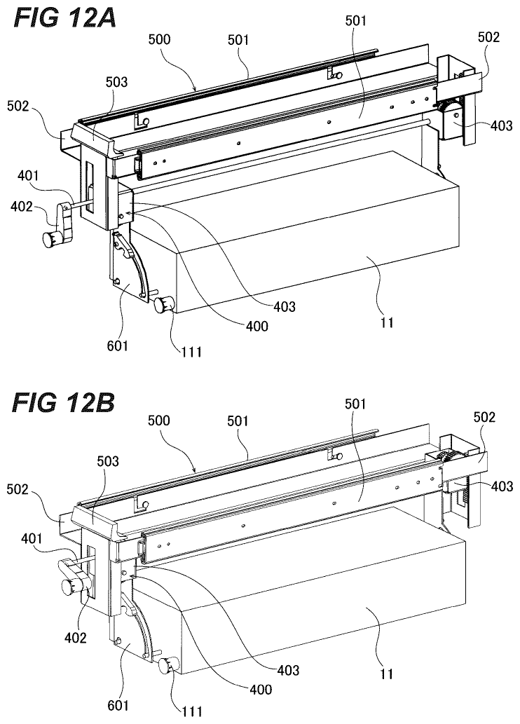

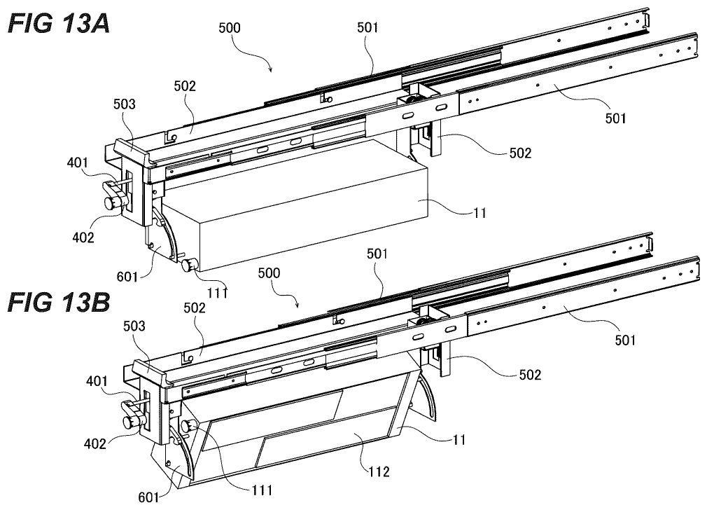

Next, a configuration of the scanner unit 11 serving as a reading portion will be described with reference to FIGS. 12A, 12B, 13A, and 13B. FIGS. 12A to 13B are perspective views illustrating a lifting and lowering operation and a rotating operation as moving operations of the scanner unit 11.

The scanner unit 11 is provided to be movable between a reading position where an image on paper can be read and a spaced-away position spaced further away from the printing belt 2201 than the reading position. FIG. 12A illustrates a case where the scanner unit 11 is located at the reading position, and FIG. 12B illustrates a case where the scanner unit 11 is located at the spaced-away position. As illustrated in FIGS. 12A and 12B, the scanner unit 11 has moved between the reading position and the spaced-away position in the vertical direction by a lifting and lowering unit 400 while a reading surface 112 faces the printing belt 2201 downward in the vertical direction. In the present embodiment, when the scanner unit 11 is located at the reading position and at the spaced-away position, the reading surface 112 is located at a facing position facing the printing belt 2201.

The lifting and lowering unit 400 will be described with reference to FIGS. 12A and 12B. As illustrated in FIGS. 12A and 12B, the lifting and lowering unit 400 includes a rotation shaft 401, a handle 402, and a pair of lifting and lowering portions 403. The rotation shaft 401 extends in the front-back direction (paper width direction) orthogonal to the conveyance direction, in which paper is conveyed, and the vertical direction. The handle 402 is fixed to one end portion in the width direction of the rotation shaft 401 so that a user (operator) can grip the handle 402 to rotate the rotation shaft 401.

The pair of lifting and lowering portions 403 are disposed to face each other at both end portions in the width direction of the rotation shaft 401, and rotatably support the rotation shaft 401. The lifting and lowering portions 403 lift and lower the scanner unit 11 in the vertical direction according to the rotation of the rotation shaft 401. However, a holding plate 601 is provided below each of the lifting and lowering portions 403 in the vertical direction, and the holding plate 601 rotatably holds the scanner unit 11. In the present embodiment, when the user rotates the handle 402, the holding plate 601 is moved in the vertical direction together with the lifting and lowering portion 403 and the rotation shaft 401, and the scanner unit 11 held by the holding plate 601 is lifted and lowered accordingly.

According to the lifting and lowering unit 400 described above, the user can lift and lower the scanner unit 11 in the vertical direction by operating the handle 402. In the present embodiment, when the user wants to clean the reading surface 112 of the scanner unit 11, the user first needs to move the scanner unit 11 from the reading position (see FIG. 12A) to the spaced-away position (see FIG. 12B). In this case, the user grips and operates the handle 402 to rotate the rotation shaft 401 in a clockwise direction. Then, the lifting and lowering portion 403 moves upward in the vertical direction, so that the scanner unit 11 held by the holding plate 601 moves to the spaced-away position. The spaced-away position is a position farther from the printing belt 2201 than the reading position.

In addition, the scanner unit 11 is provided to be movable between a facing position, where the reading surface 112 faces the printing belt 2201, and a non-facing position (hereinafter, referred to as a pulled-out position), where the reading surface 112 does not face the printing belt 2201, in the front-back direction in a state where the scanner unit 11 is located at the spaced-away position described above (see FIG. 12B). FIG. 13A illustrates a case where the scanner unit 11 is located at the pulled-out position. As illustrated in FIG. 13A, the scanner unit 11 is slid and moved between the spaced-away position (facing position) and the pulled-out position in the width direction by a pulling-out unit 500 in a state where the reading surface 112 faces downward in the vertical direction.

The pulling-out unit 500 will be described with reference to FIGS. 12B and 13A.

FIG. 12B illustrates a state in which the scanner unit 11 is located at the spaced-away position, that is, a state before the scanner unit 11 is pulled out to the pulled-out position. As illustrated in FIG. 12B, the pulling-out unit 500 includes a pair of slide rails 501 extending in the width direction with a gap in the conveyance direction, and a movable frame 502 holding the lifting and lowering unit 400 and provided slidably along the slide rails 501 so as to be movable between the spaced-away position and the pulled-out position. The slide rails 501 are fixed to a housing of the printing module 2000. A frame gripping portion 503 for the user to grip is provided on one end side in the width direction of the movable frame 502 to slide the movable frame 502.

When the user wants to clean the reading surface 112 of the scanner unit 11, the user needs to move the scanner unit 11 from the reading position (see FIG. 12A) to the spaced-away position (see FIG. 12B), and then move from the spaced-away position (facing position) to the pulled-out position (see FIG. 13A).

In this case, the scanner unit 11 is lifted from the reading position to the spaced-away position (the position illustrated in FIG. 12B) by manually rotating the handle 402. Thereafter, the user grips the frame gripping portion 503, and pulls out the movable frame 502 toward the near side. Then, the movable frame 502 slides to the pulled-out position along the slide rails 501. As a result, the lifting and lowering unit 400 also moves to the pulled-out position, so that the scanner unit 11 held by the holding plate 601 moves to the pulled-out position. In the present embodiment, when the scanner unit 11 is located at the pulled-out position, it is pulled out from the inside of the housing of the printing module 2000 to the outside of the housing of the printing module 2000 toward the near side beyond the housing, and the reading surface 112 is exposed to the outside of the housing of the printing module 2000.

Thereafter, in order to facilitate a wiping operation (see FIG. 13B), the scanner unit 11 is rotated by approximately 90° using a rotation operation lever 111, so that the reading surface 112 can be visually recognized for cleaning. In the present embodiment, the lifting and lowering function is performed by operating the handle 402, but the scanner unit 11 may be lifted and lowered either manually or automatically by electric power.

Note that the scanner unit 11 disposed downstream of the recording portion 2300 has a positioning configuration similar to that of the recording head 10 described above, with a difference in whether the lifting and lowering operation is automatic or manual. The scanner unit 11 is lifted and lowered only when the reading surface 112 is cleaned. Therefore, a manual method is adopted because the scanner unit 11 is lifted and lowered infrequently.

### Configuration of Maintenance Portion

A configuration of the maintenance portion 2600 will be described with reference to FIG. 2.

As described above, the maintenance portion 2600 includes the cap tray 18 in which the cap mechanism (not illustrated) is disposed and a cleaning tray 19 in which the cleaning mechanism (not illustrated) is disposed. The cap tray 18 and the cleaning tray 19 are configured to be individually movable in the left-right direction of the printing module 2000 along a rail (not illustrated) provided in the printing module 2000. The rail is a guide mechanism that guides a movement in the left-right direction while supporting end portions of the cap tray 18 and the cleaning tray 19 in the paper width direction (front-back direction).

The cap tray 18 and the cleaning tray 19 are positioned upstream (to the right side) of the recording portion 2300 in the sheet conveyance direction in the recording state in which recording is performed on paper by the recording head 10. In the recording state, the cap tray 18 is positioned directly above the cleaning tray 19. The positions of the cap tray 18 and the cleaning tray 19 in the recording state are also referred to as a standby position.

When the ink ejection surface of the recording head 10 is in a capped state by the cap mechanism, the cap tray 18 is positioned directly below the recording head 10 of the recording portion 2300, and the cleaning tray 19 is positioned upstream of the recording portion 2300 in the paper conveyance direction. That is, in the cap state, the cap tray 18 has moved from the standby position to a capping position downstream in the paper conveyance direction along the rail, and the cleaning tray 19 is located at the standby position.

In the cleaning state in which the ink ejection surface of the recording head 10 is cleaned by the cleaning mechanism, the cleaning tray 19 is located immediately below the recording head 10 of the recording portion 2300, and the cap tray 18 is located upstream of the recording portion 2300 in the paper conveyance direction. That is, in the cleaning state, the cleaning tray 19 has moved from the standby position to a cleaning position downstream in the paper conveyance direction along the rail, and the cap tray 18 is located at the standby position.

Each cap mechanism in the cap tray 18 includes a plurality of spherical positioning members (not illustrated) for positioning the recording head 10 with respect to the cap mechanism. The positioning members are disposed at both ends of each cap mechanism in the paper width direction (front-back direction). That is, the positioning members are provided similarly to the positioning members 811a to 811c in the printing belt unit 2200. By engaging the positioning portions 211a to 211c of each recording head 10 with the positioning members of the cap mechanism, the recording head 10 and the cap mechanism can be positioned.

Similarly to the positioning members of the cap mechanism, the cleaning tray 19 includes a plurality of spherical positioning members (not illustrated) for positioning the recording head 10 with respect to the cleaning tray 19. That is, the positioning members are provided similarly to the positioning members 811a to 811c in the printing belt unit 2200. By engaging the positioning portions 211a to 211c of each of the recording heads 10 with the positioning members of the cleaning tray 19, the recording head 10 and the cleaning tray 19 can be positioned.

The cleaning tray 19 includes a moving mechanism (not illustrated) that moves the cleaning mechanism (not illustrated) that recovers the ejection performance of the recording head 10 along a wiping direction (front-back direction) orthogonal to the paper conveyance direction. The cleaning mechanism recovers the ejection performance of the recording head 10 by removing ink and dust attached to the ink ejection surface of the recording head 10 while being moved in the wiping direction by the moving mechanism.

### Configuration of Main Body Frame

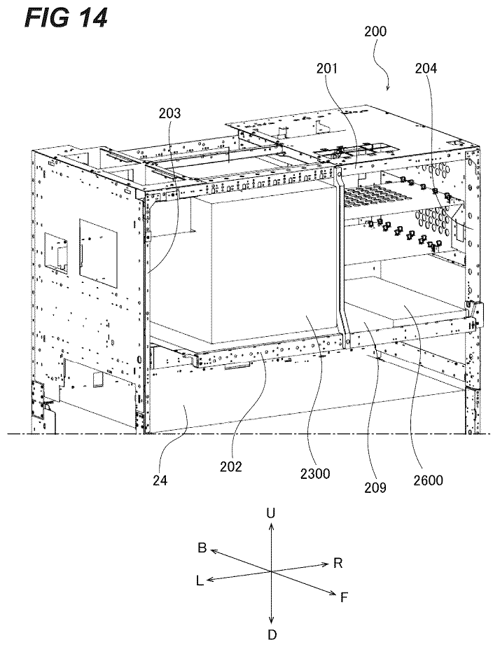

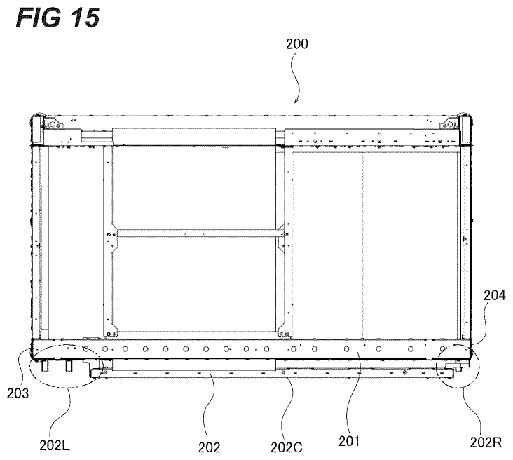

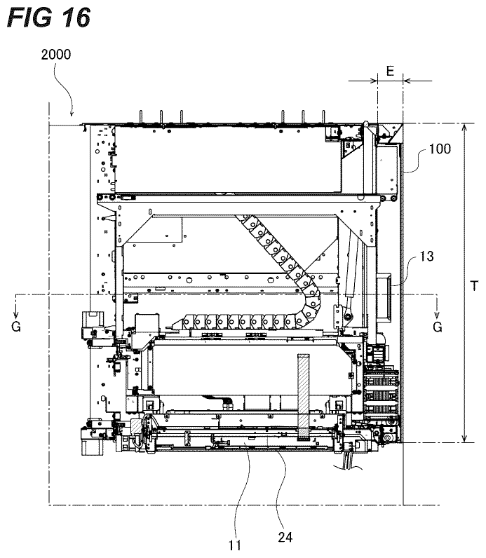

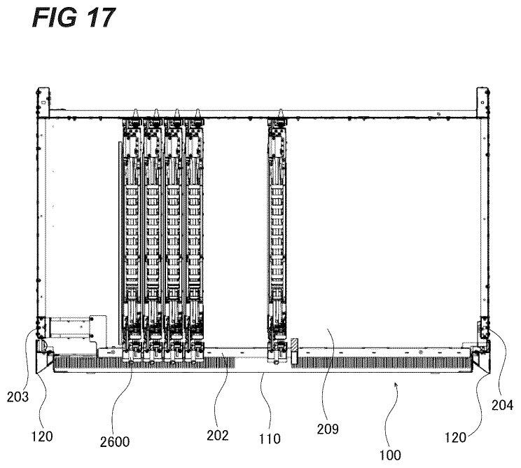

Next, the main body frame 200 of the printing module 2000 will be described with reference to FIGS. 14, 15, 16, and 17. FIG. 14 is a perspective view illustrating a state in which the recording portion 2300 and the maintenance portion 2600 are mounted on the main body frame 200 of the printing module 2000. FIG. 15 is a schematic view of the main body frame of the printing module as viewed from directly above. FIG. 16 is a left cross-sectional view of the printing module 2000. FIG. 17 is a cross-sectional view of the printing module 2000 taken along line G-G of FIG. 16.

The printing module 2000 includes a main body frame 200 that supports the recording portion 2300 and the printing belt unit 2200. The main body frame 200 includes an upper horizontal column 201, a middle horizontal column 202, a left support column 203, a right support column 204, etc.

The main body frame 200 includes a left support column 203 and a right support column 204 provided on both sides in the left-right direction. Each of the left support column 203 and the right support column 204 extends in the vertical direction. In other words, the left support column 203 and the right support column 204 are provided to face each other in the left-right direction of the main body frame 200. The left support column 203 is disposed on the left front side of the main body frame 200, and the right support column 204 is disposed on the right front side of the main body frame 200.

The recording portion 2300, the scanner unit 11, and the maintenance portion 2600 are supported by the main body frame 200. The recording portion 2300, the scanner unit 11, and the maintenance portion 2600 are disposed between the left support column 203 and the right support column 204 of the main body frame 200. The scanner unit 11 is disposed to the left side of the recording portion 2300 between the left support column 203 and the right support column 204 of the main body frame 200. That is, the scanner unit 11 is disposed between the left support column 203 and the recording portion 2300. The maintenance portion 2600 is disposed to the right side of the recording portion 2300 between the left support column 203 and the right support column 204 of the main body frame 200. That is, the maintenance portion 2600 is disposed between the right support column 204 and the recording portion 2300.

In the main body frame 200, the upper horizontal column 201 is provided so as to span in the left-right direction between the left support column 203 and the right support column 204 of the main body frame 200. The upper horizontal column 201 is connected to an upper end of the left support column 203 and an upper end of the right support column 204. The middle horizontal column 202 is provided so as to span in the left-right direction between the left support column 203 and the right support column 204 of the main body frame 200, and is provided below the upper horizontal column 201. The middle horizontal column 202 is connected to each of the left support column 203 and the right support column 204. As illustrated in FIG. 14, the upper horizontal column 201 and the middle horizontal column 202 are disposed so as to extend in the left-right direction.

The recording portion 2300, the scanner unit 11, and the maintenance portion 2600 are disposed below the upper horizontal column 201 of the main body frame 200. With respect to the relative relationship with the middle horizontal column 202, the recording portion 2300 is disposed above the middle horizontal column 202. In other words, the recording portion 2300 is disposed between the upper horizontal column 201 and the middle horizontal column 202 of the main body frame 200. On the other hand, the scanner unit 11 is disposed below the middle horizontal column 202. In addition, the maintenance portion 2600 is disposed across above and below the middle horizontal column 202.

### Size of Main Body Frame

Here, a size in the front-back direction of the main body frame 200 will be described.

As described above, the recording portion 2300 includes a plurality of sets of recording heads 10 and head holders 26, which are attached to the upper horizontal column 201 and the middle horizontal column 202 of the main body frame 200. A size (near side-to-far side dimension) in the front-back direction of the recording portion 2300 is mainly determined from the following requirements (1) and (2).

(1) A width in the longitudinal direction (front-back direction) of the nozzle plate 223 of the recording head 10 is a width of maximum-size paper +α (an ink application margin region for absorbing a deviation in sheet position). (2) The abutting portions 221 to be engaged with positioning members 811 arranged for the recording head 10 to land on the printing belt unit 2200 are arranged in a near side-to-far side region of the nozzle plate 223 of the recording head 10. The near side-to-far side dimension of the recording portion 2300 is determined by adding the head holder 26 and the recording head lifting and lowering frame 28, which has a function of lifting and lowering the recording head 10, to a near side-to-far side (longitudinal) dimension of the recording head 10 required from these requirements.

In addition, a near side-to-far side (longitudinal) dimension of the maintenance portion 2600 is determined by the following requirements (1) to (4).

(1) A near side-to-far side dimension of a configuration for the recording head 10 to land, similar to the printing belt unit 2200 for the recording head 10 to land on the cap mechanism or the cleaning mechanism. (2) A near side-to-far side dimension of the cap tray 18 holding the cap mechanism and the configuration for the head to land. (3) A near side-to-far side dimension of the cleaning tray 19 holding the cleaning mechanism and the component for the head to land. (4) A near side-to-far side dimension of a rail configuration that moves each of the cap tray 18 and the cleaning tray 19 in the left-right direction below the recording portion 2300. The near side-to-far side dimension of the maintenance portion 2600 is determined from these requirements.

A position in the front-back direction of the middle horizontal column 202 in the main body frame 200 is determined from the two configuration requirements: the near side-to-far side dimension of the recording portion 2300 and the near side-to-far side dimension of the maintenance portion 2600. In order to use a space inside the front door 100 serving as an exterior cover to be described later, the middle horizontal column 202 has its connection portions with the left and right support columns offset toward the far side.

Specifically, as illustrated in FIG. 15, the middle horizontal column 202 has a recess 202L, a protrusion 202C, and a recess 202R. In the left-right direction, the protrusion 202C is located between the recess 202L and the recess 202R. That is, the middle horizontal column 202 extends in the left-right direction. The recess 202L of the middle horizontal column 202 is connected to the left support column 203. The recess 202R of the middle horizontal column 202 is connected to the right support column 204. In the front-back direction, the protrusion 202C is offset toward the near side with respect to the recess 202L and the recess 202R. That is, the middle horizontal column 202 has an offset portion (protrusion 202C) protruding toward the front side in the front-back direction. From the opposite perspective, portions (that is, the recess 202L and the recess 202R) facing a front door frame 120 of the front door 100 to be described later on both sides in the left-right direction are offset toward the far side. The protrusion 202C between the recess 202L and the recess 202R on both sides of the middle horizontal column 202 is accommodated in an internal space (region E illustrated in FIG. 17) surrounded by the front door frame 120 of the front door 100. In other words, the position in the front-back direction of at least a part of the protrusion 202C is the same as the position in the front-back direction of the front door frame 120 of the front door 100 in the closed state. That is, when viewed in a line of sight along the left-right direction, the front door frame 120 of the front door 100 and the protrusion 202C at least partially overlap each other.

On a front surface of the main body frame 200, the recording portion 2300 is attached to and held by the middle horizontal column 202 and the upper horizontal column 201. With this configuration, the recording portion 2300 is supported so as to be movable in the front-back direction as illustrated in FIG. 11, and can be pulled out to the near side of the main body frame 200.

The middle horizontal column 202 is disposed between the left support column 203 and the right support column 204 on the front surface of the main body frame 200 to support internal units such as the recording portion 2300 and the maintenance portion 2600 that moves in the paper conveyance direction. In the main body frame 200, there is an internal space 209 in which the recording portion 2300 and the maintenance portion 2600 are arranged on a rearward side of the middle horizontal column 202 (an inner side of the main body frame). The recording portion 2300 passes through the internal space 209 on the rearward side of the middle horizontal column 202 during the lifting and lowering operation in the vertical direction. In addition, the maintenance portion 2600 passes through the internal space 209 on the rearward side of the middle horizontal column 202 during the movement operation in the left-right direction.

Usually, it is desirable that the middle horizontal column 202 having a function of supporting units is linearly connected within a region sandwiched between the left and right support columns in the horizontal cross section from the viewpoint of frame rigidity.

Here, in the middle horizontal column 202, a region where the front door frame 120 of the front door 100 does not exist when viewed from the front side entirely or partially protrudes to the front side beyond a space sandwiched between the left support column 203 and the right support column 204. That is, the protrusion 202C between the recess 202L and the recess 202R on both sides of the middle horizontal column 202 protrudes to the front side beyond the left support column 203 and the right support column 204. As a result, it is possible to secure a wide internal space 209 on the rearward side of the middle horizontal column 202 as much as the thickness of the front door frame 120 of the front door 100 at the maximum, thereby suppressing the overall size of the main body frame 200 to be small.

In addition, since the front door 100 to be described later is opened upward and is entirely covered by a transparent cover 110, it is possible to provide a wide and uniform protrusion-allowed region of the front door 100 where the front door frame 120 is not located between the left and right support columns. For example, if the front door 100 is not opened upward but is opened in a double manner, a frame is required at a divided portion of the door, and in this region, the protrusion of the middle horizontal column 202 in the front direction is hindered, so the protrusion-allowed region cannot be uniformly taken, making it difficult to ensure the rigidity of the middle horizontal column 202.

In this manner, the middle horizontal column 202 takes a uniform protruding shape, and the rigidity of the end region of the middle horizontal column 202, which is not included in the drive paths of the internal units, is ensured, thereby ensuring the rigidity of the middle horizontal column.

### Configuration of Front Door

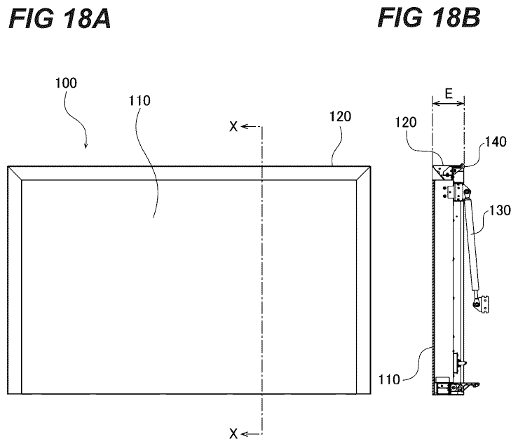

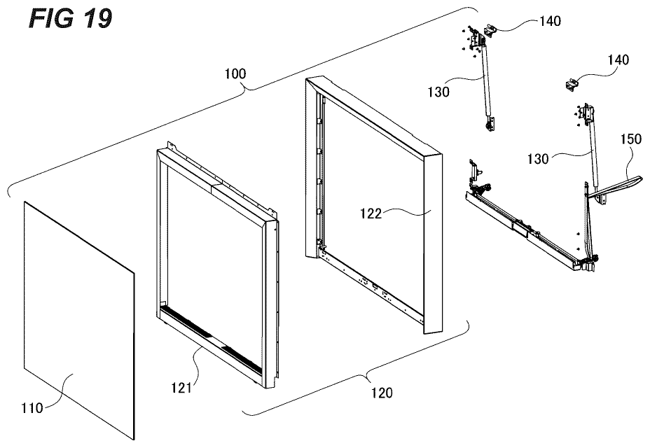

Next, the front door 100 serving as an exterior cover that forms the exterior of the front surface of the printing module 2000 on the near side of the recording portion 2300 will be described with reference to FIGS. 16, 17, 18A, 18B, and 19. FIG. 18A is an overall schematic view of the front door of the printing module. FIG. 18B is a cross-sectional view of the front door of the printing module taken along line X-X of FIG. 18A. FIG. 19 is a structural exploded view of the front door of the printing module.

The printing module 2000 includes a front door 100 that forms the exterior of the front surface of the printing module 2000 on the near side of the recording portion 2300 in the front-back direction orthogonal to the vertical direction and the left-right direction. The front door 100 is disposed on the front side of the recording portion 2300 in the front-back direction, and is attached to the main body frame 200 so as to form the exterior of the front surface. The front door 100 is provided on the main body frame 200 so as to be openable and closable. The front door 100 has a transparent cover 110 formed of a transparent material over the entire front surface. The front door 100 is opened and closed by rotating about a rotation shaft on the upper end side in the vertical direction.

That is, the front door 100 is attached to the front side of the main body frame 200. The front door 100 includes a transparent cover 110 serving as an exterior cover, and a front door frame 120 serving as a frame member (cover frame) having a certain degree of thickness for maintaining the rigidity of the front door 100. The front door frame 120 is disposed around at least a part of the transparent cover 110. In the present embodiment, the front door frame 120 surrounds four sides of the transparent cover 110. As a modification, the front door frame 120 may surround only three sides or only two sides of the transparent cover. Alternatively, the front door frame 120 may be provided only on a part of one side of the transparent cover. The transparent cover 110 is attached to an outer side in the thickness direction of the front door frame 120. In other words, the transparent cover 110 is disposed on a front end side in the front-back direction of the front door frame 120. Here, the front end side refers to a region between the center and the front end in the front-back direction of the front door frame 120.

In addition, when the front door 100 is closed, the front door frame 120 is located at a position supported by the main body frame 200 when viewed from the front side, whereby the front door 100 does not enter the internal space 209 inside the middle horizontal column 202 of the main body frame 200.

The front door 100 is formed to entirely cover a region T (see FIG. 16) above the paper conveyance surface 24 of the printing belt 2201 that conveys paper. Further, as illustrated in FIGS. 18A and 18B, the front door 100 is provided with the transparent cover 110 so that the recording portion 2300 and other units in the apparatus can be visually recognized from the outside of the apparatus even during a printing operation. Making it possible to visually recognize the inside of the apparatus contributes not only to making it possible to visually recognize an operating state of the image forming apparatus, but also to making it possible to determine whether or not it is necessary to clean the inside of the apparatus due to adhesion of ink mist.

From the viewpoint of design, the transparent cover 110 is configured as a single unit (front door unit) from the paper conveyance surface 24 (see FIG. 14) to an upper portion of the front door 100 so that a region as wide as possible including the recording portion 2300 can be visually recognized. The transparent cover 110 is formed such that transparent cover 110 occupies 85% of the area in the longitudinal direction of the front door 100.

Specifically, the front door frame 120 serving as a cover frame has a left side portion as a cover frame portion facing the left support column 203 and a right side portion as a cover frame portion facing the right support column 204. The transparent cover 110 is disposed across from the left side portion to the right side portion. In this manner, the front door 100 is formed of the transparent cover 110 from the left support column 203 to the right support column 204 in the left-right direction of the main body frame 200.

Further, the front door 100 is formed of the transparent cover 110 from the upper horizontal column 201 to the paper conveyance surface 24 of the printing belt unit 2200 in the vertical direction of the main body frame 200. As illustrated in FIG. 14, the paper conveyance surface 24 of the printing belt unit 2200 is located below the middle horizontal column 202 of the main body frame 200. Therefore, it can also be said that the front door 100 is formed of the transparent cover 110 from the upper horizontal column 201 to the middle horizontal column 202 in the vertical direction of the main body frame 200.

With this configuration, an operating state of the printing module 2000 can be visually observed through the transparent cover 110 without opening the front door 100. For example, a lifting and lowering operation and a position of the recording head 10, an operation and a position of the maintenance portion 2600, a position of the scanner unit 11, a state in which paper is conveyed, etc. can be visually recognized. In addition, a contamination state in the vicinity of the recording portion can be visually recognized from the outside of the apparatus even when the apparatus is in operation, making it possible to determine whether cleaning is needed.

The transparent cover 110 is made of a transparent resin plastic material selected in consideration of weight and crack resistance, and is made as thin (=light) as possible without impairing texture. Since the transparent cover 110 is made of a thin resin plastic material, the rigidity of the front door 100 is ensured by making the thickness (region E) in the front-back direction of the front door frame 120 thicker than the thickness in the front-back direction of the transparent cover 110. That is, the thickness in the front-back direction of the front door frame 120 is larger than the thickness in the front-back direction of the transparent cover. Specifically, the thickness of the transparent cover 110 is 5 mm, and the thickness (region E) of front door frame 120 is equal to or larger than the thickness of the transparent cover 110 (30 mm or more).

Here, the front door frame 120 has a thickness of 50 mm in the front-back direction. The transparent cover 110 has a thickness of 5 mm in the front-back direction. The transparent cover 110 is disposed on the front end side in the front-back direction of the front door frame 120. That is, the transparent cover 110 is disposed on a large outer surface of the front door 100. Therefore, the front door 100 has an internal space (region E) of 45 mm inside the transparent cover 110.

Then, as illustrated in FIG. 16, by arranging components for the respective elements of the apparatus in the internal space (region E) of the front door 100, this contributes to reducing the near side-to-far side dimension of the apparatus. As illustrated in FIG. 17, in a state where the recording portion 2300 is attached to the middle horizontal column 202 of the main body frame 200, the middle horizontal column 202 and the recording portion 2300 are accommodated inside the thickness (region E) of the front door frame 120 of the front door 100.

In other words, the left support column 203, the right support column 204, and the upper horizontal column 201 of the main body frame 200 described above face the front door frame 120 of the front door 100 in the front-back direction. The left support column 203, the right support column 204, and the upper horizontal column 201 of the main body frame 200 are offset toward the far side beyond a front end portion of the recording portion 2300 supported by the main body frame 200. As a result, the main body frame 200 is downsized, and the front end portion in the front-back direction of the recording portion 2300 enters the internal space of the front door 100 by the thickness (45 mm) in the front-back direction of the front door frame 120.

Specifically, as described above, the recording portion 2300 includes the handle 13 at the front end in the front-back direction of the recording head lifting and lowering frame 28. The recording portion 2300 is supported so as to be movable in the front-back direction with respect to the main body frame 200. The handle 13 is disposed in the internal space (region E) of the front door 100 surrounded by the front door frame 120 on the front side beyond the upper horizontal column 201 of the main body frame 200. In other words, the position in the front-back direction of at least a part of the handle 13 is the same as the position in the front-back direction of the front door frame 120 of the front door 100 in the closed state. That is, when viewed in a line of sight along the left-right direction, the front door frame 120 of the front door 100 and the handle 13 at least partially overlap each other.

As described above, the scanner unit 11 includes the handle 402 at the front end in the front-back direction of the scanner unit 11. The handle 402 is disposed in the internal space (region E) of the front door 100 surrounded by the front door frame 120 on the front side beyond the upper horizontal column 201 of the main body frame 200.

In this manner, by providing the front door frame 120 of the front door 100 with a thickness in the front-back direction to form an internal space (region E), this contributes to reducing the near side-to-far side dimension of the apparatus.

The configuration of the front door 100 will be described in more detail with reference to FIG. 19. The front door 100 includes the transparent cover 110, a front door frame 120 that forms the periphery of the transparent cover 110, a gas spring 130 that assists an opening and closing force, an upper hinge 140, and a hanging string 150.

The front door frame 120 of the front door 100 has a design using two painting colors. The front door frame 120 includes a first frame 121 and a second frame 122. The first frame 121 is painted after being formed in a square shape by welding and fastening a plurality of parts. The second frame 122 is coated in a color different from that of the first frame 121 after being formed in a square shape by welding and fastening a plurality of parts. The front door frame 120 is formed by fastening the first frame 121 and the second frame 122 with screws after being painted. The first frame 121 and the second frame 122 constituted by a plurality of parts are painted after the welding in order to provide rigidity in a state where the parts are assembled in the square shape.

The transparent cover 110 is bonded and fixed to the front end side of the front door frame 120 in the front-back direction by an adhesive. Further, the gas spring 130, the upper hinge 140, and the hanging string 150 are attached to predetermined positions of the front door frame 120.

### Opening and Closing of Front Door

The upper hinge 140 is attached to an upper end of the front door 100, and the upper hinge 140 is attached to the upper horizontal column 201 of the main body frame 200. The front door 100 can take an opened state and a closed state by rotating about (a shaft member 161 of) the upper hinge 140. In this manner, the front door 100 is supported by the main body frame 200 in an openable and closable manner.

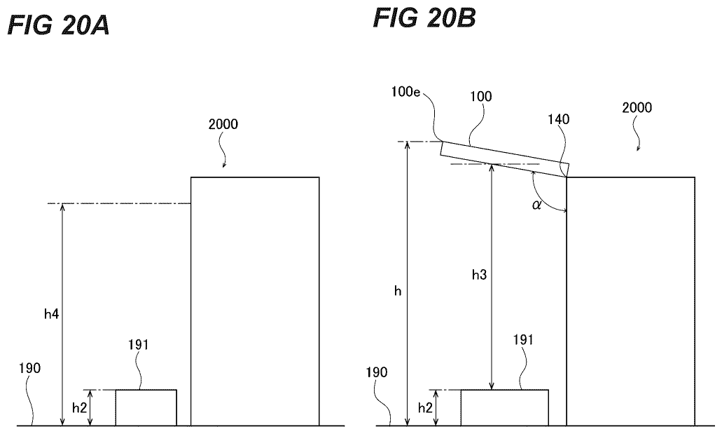

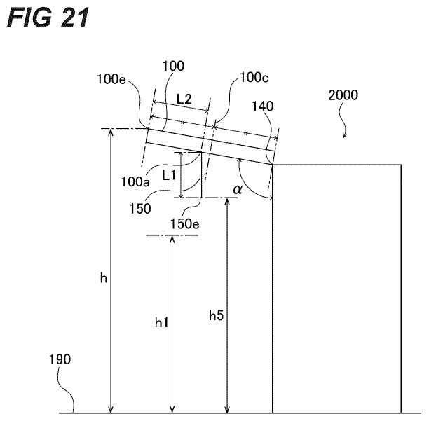

An opening and closing operation of the front door 100 of the printing module 2000 will be described with reference to FIGS. 3, 20A, 20B, and 21. FIGS. 20A and 20B are views in which the front door of the printing module is opened upward. FIG. 21 is a view for explaining a hanging string of the front door opened upward.

The front door 100 covering the recording portion 2300 of the printing module 2000 is opened upward with an upper end of the printing module 2000 being a base point as illustrated in FIG. 3. The front door 100 has a lever (not illustrated) for releasing the latch at the center of the lower side. When the lever is gripped and the latch is released, the front door 100 is opened upward by the upper hinge 140, and the opening of the front door 100 in the opening direction is assisted by the gas spring 130 until it hits a stopper (not illustrated) provided at the opened position and is maintained in the opened state.

If the front door 100 is not opened upward but is opened in a double manner in the left-right direction, after the recording portion is pulled out to the near side from the printing module when replacing the recording head, it would not be possible to obtain a sufficient space for an operator to go around to the left side of the recording portion and perform an operation, making the operation difficult. Therefore, it is preferable that the front door 100 is opened upward. In addition, since the image forming apparatus according to the present embodiment is formed by connecting a plurality of modules having different functions, if an error or a jam occurs and paper is stuck inside the main body, it is necessary to access the plurality of modules in succession. In such a case, it is preferable that the front door 100 is opened upward because this does not hinder a lateral movement of a module adjacent to the printing module.

That is, by opening the front door 100 upward, the opened front door does not hinder a lateral movement of a module adjacent to the printing module 2000 during jam recovery across the plurality of modules. In addition, when the recording head 10 is replaced, it is easily inserted through a side surface of the recording portion 2300 drawn out to the front, making the replacement easy. In addition, by providing the transparent cover 110 on the front door 100 that is opened upward, even in a case where the front door 100 is opened, illumination from the ceiling is taken through the transparent cover 110, making it possible to obtain an effect that the inside of the apparatus is easily viewed.

The maximum opening angle α when the front door 100 is opened upward about the upper end is set as follows. A height in the vertical direction from an installation surface 190 of the image forming apparatus to a free end 100e that is a lower end of the front door 100 at a position of the front door 100 opened to the maximum opening angle is defined as h. A lower limit value of a height of an operator is defined as h1 (e.g., 1470 mm), and an upper limit value of a height of an operator is defined as h3 (e.g., 1970 mm). A predetermined height of a workbench 191 for an operator having a height of the lower limit value h1 is defined as h2 (e.g., 320 mm). In addition, a height h4 illustrated in FIG. 20A is a height (eye height) to the eye of the operator having a height of the lower limit value h1 standing on the workbench 191, and the height h2 of the workbench 191 is set such that the height h4 is a predetermined height (e.g., 1670 mm). The opening angle α of the front door 100 is set to an opening angle α at which the height h in the vertical direction to the free end 100e of the front door 100 is higher than a height h3+h2 in the vertical direction when an operator having a height of the upper limit value h3 stands on the workbench 191 having the predetermined height h2 for an operator having a height of the lower limit value h1.

Specifically, the opening angle α of the front door 100 about the upper end is set to 100±10°. That is, the maximum opening angle α of the front door 100 falls within the range of 90 degrees to 110 degrees.

In order for a short person having a height of the lower limit value h1 to access the maintenance portion 2600, it is necessary to stand on the workbench 191 having the height h2 as illustrated in FIG. 20A. In addition, even when a tall person having a height of the upper limit value h3 stands on the workbench 191, it is needed that the head does not hit the front door 100 that is opened upward (FIG. 20B). From the viewpoint of human scale, the opening angle α of the front door 100 about the upper end is set.

However, in a state where the front door 100 is opened at an opening angle of 100°, a short person cannot close the front door 100 because the short person's hand cannot reach a distal end (free end 100e) of the front door 100. Therefore, as illustrated in FIG. 21, the front door 100 includes a hanging string 150 that assists a closing operation of closing the front door 100. The hanging string 150 is attached to an inner side of the front door 100. In this manner, by providing the hanging string 150 inside the front door 100, the hanging string 150 is first pulled to lower the front door 100, and then the front door 100 is closed by placing the other hand on the distal end portion of the front door 100.

In addition, if the hanging string 150 is too long or the hanging string 150 is attached to a position too close a distal end side of the front door 100, the hanging string 150 protrudes from the front door 100 when the front door 100 is closed, impairing the appearance quality. On the other hand, if the hanging string 150 is too short, a short person's hand does not reach the hanging string 150, and the front door 100 cannot be closed. In addition, if the hanging string 150 is attached at a position too close to a base side of the front door 100, the front door 100 may hit an operator when the front door 100 is closed.

From these perspectives, in the front door 100 that is opened upward with the upper end of the printing module 2000 being a base point, the hanging string 150 is attached at a position on a free end side with respect to a central portion 100c between the upper end (upper hinge 140), which serves as a rotation support point (opening and closing support point) of the front door 100, and the free end 100e.

An overall length L1 of the hanging string 150 is set to be shorter than a length L2 from a position 100a of the front door 100 at which the hanging string 150 is installed to the free end 100e of the front door 100.

In addition, when the front door 100 is opened to the maximum opening angle α, a height h5 from the installation surface 190 of the image forming apparatus to a lower end 150e of the hanging string 150 is equal to or less than the value set for an operator having a height of the lower limit value h1 to reach by hand.

Specifically, the upper limit height h5 of the hanging string 150 is set to 1700 mm, and the position 100a at which the hanging string 150 is attached is set to 360 mm from the distal end (free end 100e) of the front door 100 in the front-back direction. As a result, in a case where an operator having a height of the lower limit value h1 closes the front door 100, the angle of the arm when the second finger is hooked on the hanging string 150 is about 160°, and the operator having a height of the lower limit value h1 can be located outside the rotation trajectory of the front door 100, and if the operator having a height of the lower limit value h1 closes the front door 100, the front door 100 can be avoided from hitting the operator.

Note that, from the viewpoint of safety, the image forming apparatus according to the present embodiment is required to have an interlock and a door lock, and has a specification in which the front door cannot be opened when the main body is in operation because the latch is not released even if the latch lever is gripped.

Although the front door 100 provided on the front surface of the image forming apparatus is opened upward in the present embodiment, the front door 100 may be opened in any direction, and may be opened sideward or downward.

As described above, the recording portion, the handle of the recording portion, the middle horizontal column, the maintenance portion, the reading unit, the conveying belt, etc. are visually recognized through the transparent cover 110 in a state where the front door 100 is closed. For each element, only a part of the element may be visually recognized, or the entire element may be visually recognized. In addition, among the above-described elements, some elements (e.g., the reading portion) may not be visually recognized.

### Upper Hinge

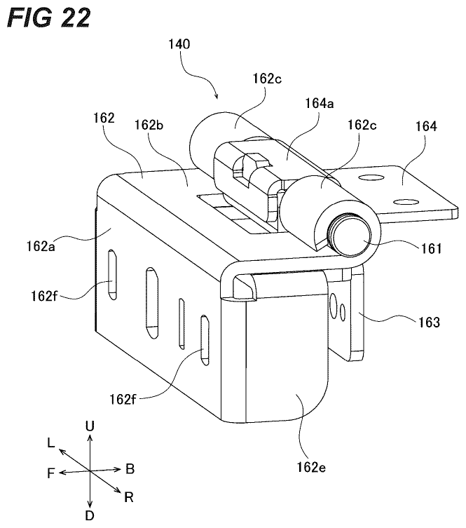

The upper hinge 140 used for the front door 100 will be described in detail with reference to FIGS. 22 to 27.

FIG. 22 is a perspective view illustrating the upper hinge 140 connecting the front door 100 and the main body frame 200. The upper hinge 140 illustrated in FIG. 22 is detached from the front door 100 and the main body frame 200 to illustrate the structure of the upper hinge 140. As illustrated in FIG. 22, the upper hinge 140 includes a shaft member 161, a shaft support member 162 (second shaft support member), a shaft support member 163 (first shaft support member), and a restricting member 164. The front door 100 is provided with a plurality of upper hinges 140.

Here, one upper hinge 140 is provided on each of the right side and the left side of the front door 100 in the left-right direction. The upper hinge 140 is attached to the upper end of front door 100 and to the upper horizontal column 201 of the main body frame 200 to connect the front door 100 and the main body frame 200. The front door 100 can take an opened state and a closed state by rotating about the shaft member 161 of the upper hinge 140.

Similarly, each of the plurality of upper hinges 140 has the configuration illustrated in FIG. 22. Hereinafter, each member will be described.

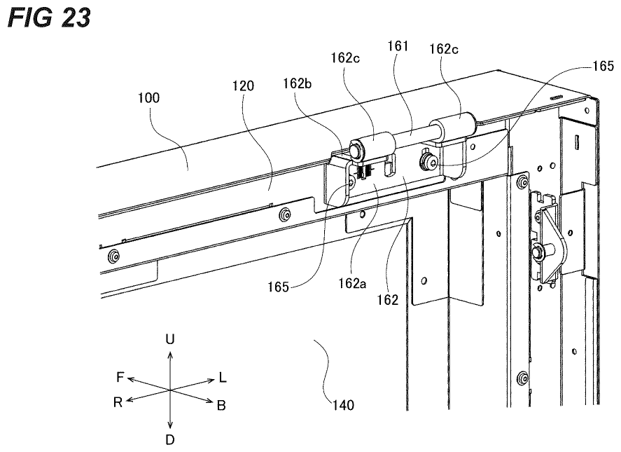

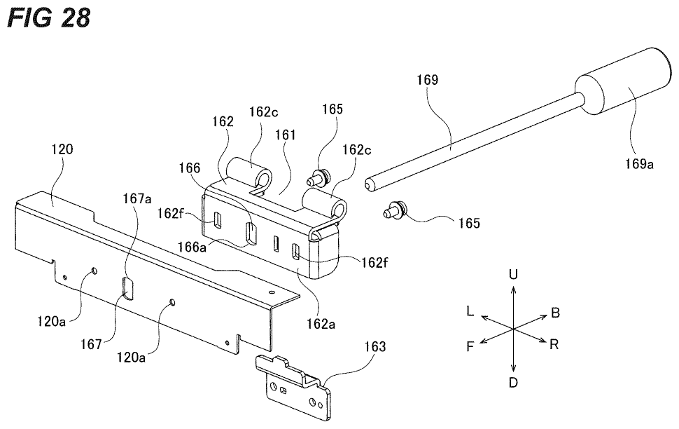

FIG. 23 is a perspective view of a part of the front door 100 and a part of the upper hinge 140 as viewed from the back. The shaft support member 162 of the upper hinge 140 is attached to the front door 100. Specifically, the shaft support member 162 of the upper hinge 140 is fixed to a back side (rear surface) of the front door frame 120 of the front door 100 by a fastening member 165. The front door frame 120 of the front door 100 has a hole 120a (see FIG. 28) for fixing the fastening member 165. The hole 120a is provided in the rear surface of the front door frame 120. On the other hand, the shaft support member 162 has an elongated hole 162f so as to face each hole 120a of the front door frame 120. The elongated hole 162f is provided in a surface (facing portion 162a) of the shaft support member 162 facing the rear surface of the front door frame 120. Here, the elongated hole 162f is a hole elongated in one direction for adjusting the position of the front door 100. Therefore, the fixed position of the front door 100 with respect to the shaft support member 162 can be adjusted by loosening the fastening of the fastening member 165.

The shaft support member 162 is formed of sheet metal. A part of the shaft support member 162 is bent to form an annular portion 162c through which the shaft member 161 is inserted. Specifically, first, the shaft support member 162 has a facing portion 162a forming a surface facing the rear surface of the front door frame 120.

Further, the shaft support member 162 has a bent portion 162b bent up from an upper end of the facing portion 162a. A distal end of the bent portion 162b, that is, a portion on a side (main body frame side) opposite to the upper end of the facing portion 162a, is further bent to form an annular portion 162c. One shaft support member 162 has two annular portions 162c. The common shaft member 161 is inserted through the two annular portions 162c. Here, it is exemplified that one shaft support member 162 has two annular portions, but the configuration is not limited thereto, and for example, one shaft support member 162 may have only one annular portion 162c.

The shaft support member 162 is bent at both ends in the left-right direction of the facing portion 162a to form support portions 162e that support the bent portion 162b from below. Further, the support portions 162e extend backward at a portion that supports the bent portion 162b from below, and also supports the annular portion 162c provided at the distal end of the bent portion 162b from below. With such a configuration, the strength and durability required for the shaft support member 162 are increased.

The shaft member 161 is formed of metal. The shaft member 161 has a columnar shape. The shaft member 161 is supported by the shaft support member 162 and the shaft support member 163. Specifically, the shaft member 161 is inserted through the annular portions 162c of the shaft support member 162 attached to the front door 100 such that the shaft member 161 and the shaft support member 162 rotate following the rotation of the front door 100. The shaft member 161 is supported by the shaft support member 163 attached to the main body frame 200. The load of the front door 100 is applied to the annular portion 162c of the shaft support member 162. Even in this case, the annular portion 162c of the shaft support member 162 has strength to such an extent that the shaft member 161 does not come off the annular portion 162c. Since the shaft support member 162 is formed of metal such as sheet metal, high durability can be obtained. However, the shaft support member 162 may be formed of resin or the like depending on the required strength. The same applies to the other members of the upper hinge 140.

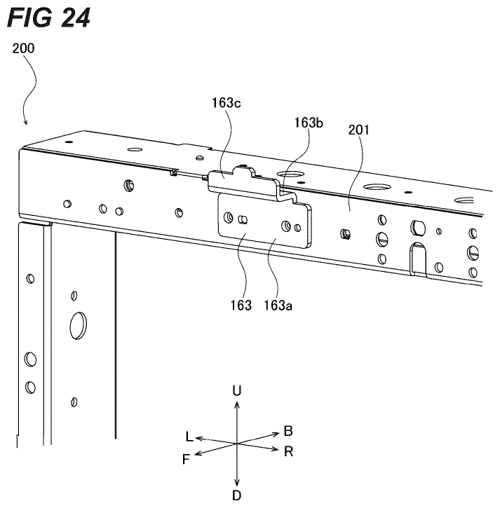

FIG. 24 is a perspective view of a part of the main body frame 200 and a part of the upper hinge 140 as viewed from the front. The shaft support member 163 of the upper hinge 140 is attached to the main body frame 200. Specifically, the shaft support member 163 of the upper hinge 140 is fixed to a front surface of the upper horizontal column 201 of the main body frame 200 by a fastening member (not illustrated). The shaft support member 163 is formed of sheet metal. A part of the shaft support member 163 is bent to form a holding portion 163b that holds the shaft member 161.

Specifically, the shaft support member 163 has a facing portion 163a forming a surface facing the front surface of the main body frame 200. Further, the shaft support member 163 has a holding portion 163b, which is a portion bent up from an upper end of the facing portion 163a. The holding portion 163b holds the shaft member 161 on its upper surface. The holding portion 163b holds the shaft member 161 inserted through the annular portions 162c of the shaft support member 162 from below. In addition, a distal end of the holding portion 163b, that is, a portion on a side (front door side) opposite to the facing portion 163a, is further bent. The bent portion provided at the distal end of the holding portion 163b constitutes a restricting portion 163c that restricts a movement of the shaft member 161 (eventually, the front door 100) in the near-side direction (in a radial direction of the shaft member 161). The restricting portion 163c has a protrusion (projection) protruding upward at an upper end thereof.

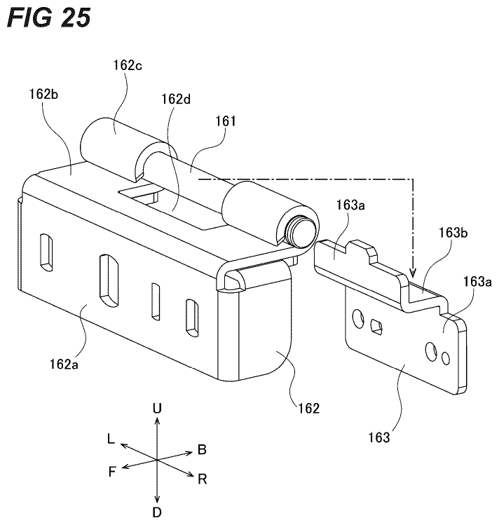

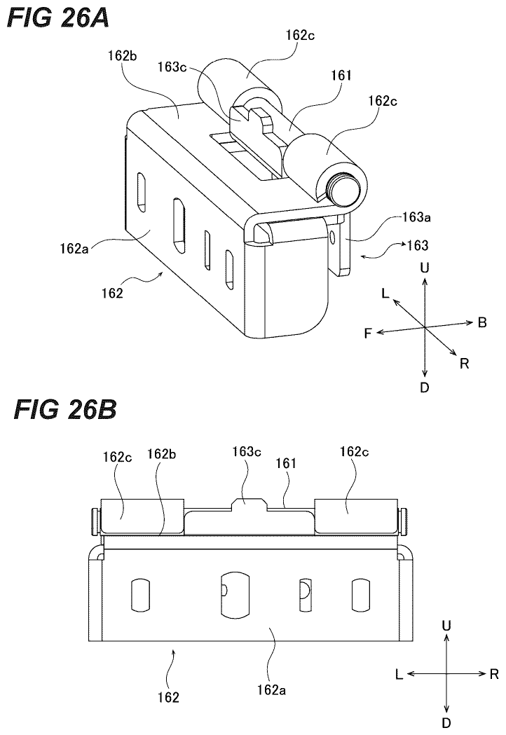

The connection between the shaft support member 162 and the shaft support member 163 will be described with reference to FIGS. 25, 26A, and 26B. FIG. 25 is a perspective view illustrating a part of the upper hinge 140. FIG. 26A is a perspective view illustrating the upper hinge 140, and FIG. 26B is a front view illustrating the upper hinge 140. FIG. 25 illustrates a process of connecting the shaft support member 162 and the shaft support member 163. On the other hand, FIGS. 26A and 26B illustrate a state in which the shaft support member 162 and the shaft support member 163 are connected.

As illustrated in FIG. 25, an opening 162d is provided in the bent portion 162b of the shaft support member 162. The opening 162d is located between the two annular portions 162c. In a state where the shaft member 161 inserted through the two annular portions 162c is placed on the upper surface of the holding portion 163b of the shaft support member 163, the restricting portion 163c of the shaft support member 163 is inserted through the opening 162d of the shaft support member 162. With such a configuration, the restricting portion 163c restricts a movement of the shaft support member 162 (eventually, the front door 100) in the left-right direction (the thrust direction of the shaft member 161). That is, as illustrated in FIGS. 26A and 26B, the shaft support member 162 and the shaft support member 163 are connected, thereby restricting a movement of the front door 100 in the near-side direction and a movement of the front door 100 in the left-right direction with respect to the main body frame 200.

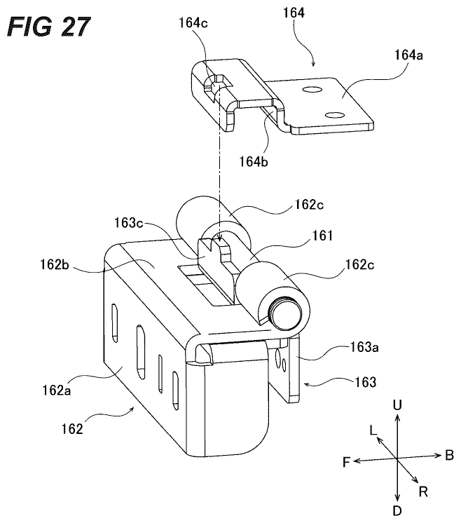

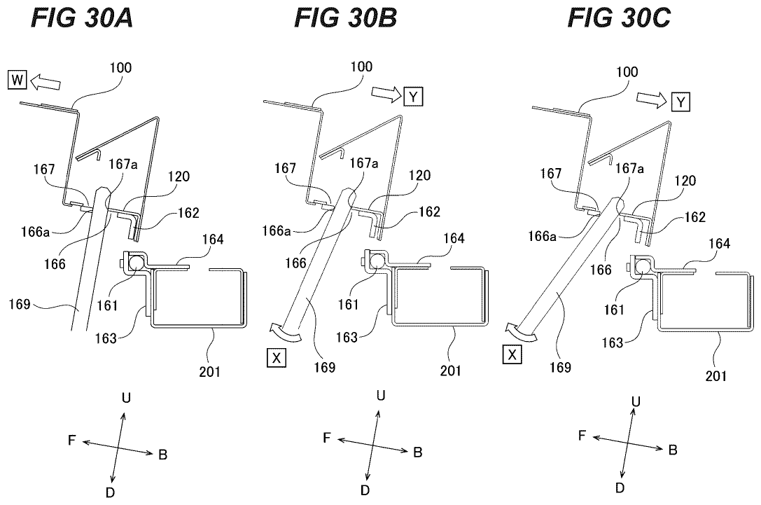

FIG. 27 is a perspective view illustrating the upper hinge 140. The restricting member 164 is further attached to the shaft support member 162 and the shaft support member 163 connected to each other. The restricting member 164 of the upper hinge 140 is fixed to an upper surface of the upper horizontal column 201 (see FIG. 30A) of the main body frame 200 by a fastening member (not illustrated).

The restricting member 164 is formed of sheet metal. A part of the restricting member 164 is bent to form a shaft cover portion 164b. Specifically, the restricting member 164 has a facing portion 164a forming a surface facing an upper surface of the main body frame 200. A portion on a front side of the facing portion 164a is bent to form a shaft cover portion 164b. When cut along a cross section including the front-back direction and the up-down direction, the cross section of the shaft cover portion 164b has a U-shape with the lower side being open. That is, a recess is formed when viewed from below. The shaft member 161 and the restricting portion 163c of the shaft support member 163 are accommodated in the recess. A length in the left-right direction of the shaft cover portion 164b is equal to or shorter than a gap between the two annular portions 162c of the shaft support member 162. Therefore, as illustrated in FIG. 22, in a state where the restricting member 164 is attached, the shaft cover portion 164b is disposed between the two annular portions 162c.

As illustrated in FIG. 27, an opening 164c is provided in the shaft cover portion 164b. In a state where the shaft member 161 and the restricting portion 163c of the shaft support member 163 are accommodated in the recess of the shaft cover portion 164b, the protrusion located at the upper end of the restricting portion 163c is inserted through the opening 164c.

In this manner, by attaching the restricting member 164 to the shaft support member 162 and the shaft support member 163 connected to each other, the restricting member 164 restricts a movement of the shaft member 161 (eventually, the front door 100) in the upward direction. As described above, the restricting portion 163c of the shaft support member 163 restricts a movement of the front door 100 in the near-side direction. That is, a relative position of the front door 100 with respect to the main body frame 200 in the radial direction of the shaft member 161 is restricted by the restricting member 164 and the restricting portion 163c of the shaft support member 163. In addition, the front door 100 is positioned relative to the main body frame 200 in the thrust direction as well by the restricting portion 163c of the shaft support member 163.

In a state where the restricting member 164 is attached, a central portion of the shaft member 161 is disposed in a region surrounded by (1) the restricting portion 163c of the shaft support member 163, (2) the holding portion 163b of the shaft support member 163, and (3) the shaft cover portion 164b of the restricting member 164. When the shaft member 161 and the shaft support member 162 rotate as the front door 100 rotates, the shaft member 161 rotates relative to the restricting portion 163c, the holding portion 163b, and the shaft cover portion 164b. The relative position of the front door 100 with respect to the main body frame 200 is restricted in the radial direction and the thrust direction of the shaft member 161. Therefore, the relative movement of the front door 100 with respect to the main body frame 200 has a degree of freedom only in a rotation direction with an extending direction of the shaft member 161 as the rotation center. With such a configuration, the shaft member 161, the shaft support member 162, the shaft support member 163, and the restricting member 164 realize the function of the upper hinge 140.

### Position Adjustment Mechanism of Front Door

Next, a mechanism for adjusting the fixed position of the front door 100 with respect to the shaft support member 162 of the upper hinge 140 will be described in detail with reference to FIGS. 28 to 31C.

As illustrated in FIG. 28, the shaft support member 162 has an adjustment hole 166, and the front door frame 120 of the front door has an adjustment hole 167. The adjustment hole 166 and the adjustment hole 167 are arranged so as to at least partially overlap each other.

The adjustment hole 167 serves as an action point when an external force for moving the front door connected to the upper hinge 140 is applied to the front door frame 120. On the other hand, the adjustment hole 166 serves as a support point when the external force is applied to the front door frame 120. Since at least a part of the adjustment hole 166 of the shaft support member 162 is disposed so as to overlap the adjustment hole 167 of the front door, a shaft member 169 can be inserted through the adjustment hole 167 and the adjustment hole 166. As a result, the adjustment hole 167 of the front door functions as an action point, and the adjustment hole 166 of the shaft support member 162 functions as a support point. More precisely, the support point is an end 166a of the adjustment hole 166 of the shaft support member 162 fixed to the main body frame. In addition, the action point is an end 167a of the adjustment hole 167 of the front door frame 120 of the front door.

With such a configuration, it is possible to apply a force utilizing the principle of leverage to the action point, using the shaft member 169 (a hand-held tool, a shaft member attached to the main body of the apparatus, or the like) that is sufficiently longer than a distance between the support point and the action point.

That is, by using the shaft member 169 serving as an insertion member inserted into the adjustment holes 166 and 167 arranged so as to overlap each other, it is possible to apply an external force to the front door, with the end 166a of the adjustment hole 166 provided in the shaft support member 162 as a support point and the end 167a of the adjustment hole 167 provided in the front door as an action point.

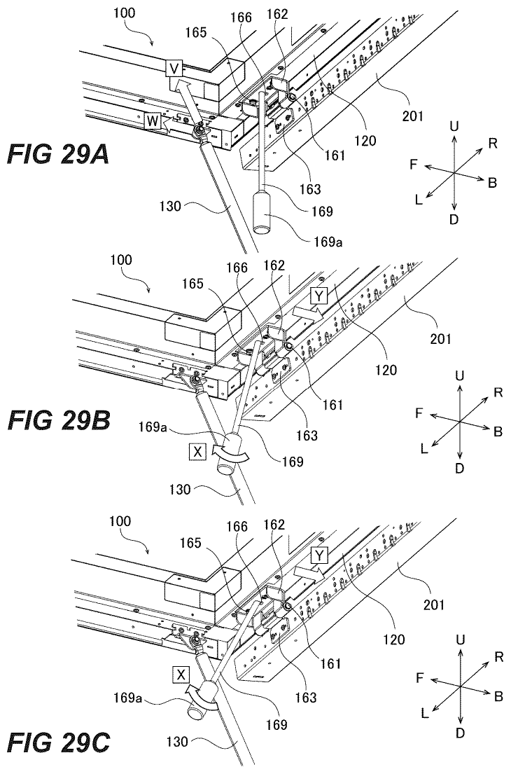

Next, a specific adjustment procedure will be described. The front door 100 includes a gas spring 130 serving as an auxiliary member that assists the opening and closing force (see FIG. 19). The gas spring 130 applies a force to the front door 100 in the opened state in an opening direction (V direction in FIG. 29A) with respect to the main body frame 200. One end of the gas spring 130 is attached to the front door frame 120. Although not illustrated, the other end of the gas spring 130 is attached to the main body frame.

As illustrated in FIG. 29A, a force is applied to the front door 100 and the front door frame 120 in the V direction by the gas spring 130. When the fastening of the fastening member 165 is loosened, the front door 100 and the front door frame 120 move in the W direction, because the shaft support member 162 is fixed to the main body frame 200. FIGS. 29A, 30A, and 31A illustrate a state in which the front door 100 and the front door frame 120 have moved in the W direction. In this state, the shaft member 169 is inserted into the adjustment hole 166 of the shaft support member 162 and the adjustment hole 167 of the front door frame 120. As described above, the shaft member 169 may be attached to the main body of the apparatus, or a general tool such as a screwdriver may be used.

As illustrated in FIG. 29B, when the shaft member 169 inserted into the adjustment hole 166 and the adjustment hole 167 is tilted in the X direction, the force amplified by the principle of leverage is applied to the front door 100 and the front door frame 120, and the front door 100 and the front door frame 120 move in the Y direction. FIGS. 29B, 30B, and 31B illustrate a state in the middle of adjustment during which the front door 100 and the front door frame 120 are moving in the Y direction opposite to the W direction.

As described above, by using the shaft member 169 inserted into the adjustment holes 166 and 167 arranged so as to overlap each other, the external force is applied to the front door 100 and the front door frame 120, with the end of the adjustment hole provided in the shaft support member 162 as a support point and the end of the adjustment hole provided in the door as an action point. At this time, a distance from a force point (a grip portion 169a of the shaft member 169) at which the external force is applied to the shaft member 169 to the support point (the end 166a) is larger than a distance from the support point (the end 166a) to the action point (the end 167a). Therefore, when the shaft member 169 inserted into the adjustment hole 166 and the adjustment hole 167 is tilted in the X direction, the force amplified by the principle of leverage is applied to the front door 100 and the front door frame 120. That is, the force applied to the force point is amplified by the principle of leverage, and the amplified force is applied to the action point. Therefore, even if the force used to operate the shaft member 169 is small, the force amplified by the principle of leverage is applied to the front door 100 and the front door frame 120, making it easy to adjust the position of the front door 100.

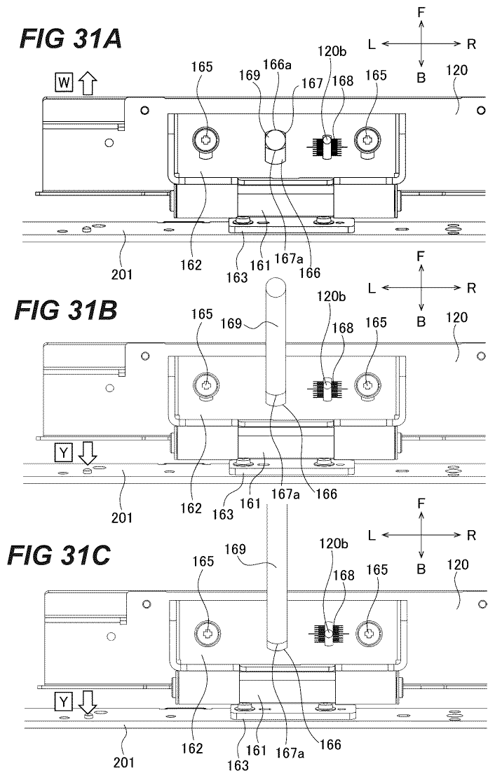

As illustrated in FIG. 29C, when the shaft member 169 is further tilted in the X direction, the front door 100 and the front door frame 120 further move in the Y direction. A scale 168 (see FIGS. 31A to 31C) indicating a standard of a movement amount is engraved on the shaft support member 162. On the other hand, a mark 120b (see FIGS. 31A to 31C) is provided on the front door frame 120 at a position facing the scale 168 of the shaft support member 162. The mark 120b moves together with the front door frame 120, and moves along the scale 168. Therefore, the movement (position adjustment) of the front door 100 can be completed using the scale 168 as a reference. FIGS. 29C, 30C, and 31C illustrate views of the front door 100 and the front door frame 120 in a state where the adjustment is completed. In this embodiment, the adjustment is performed using scale 0 as a reference, but since the reference changes depending on variations in tolerance of the parts, it is necessary to perform adjustment for each individual part. When the shaft member 169 is held with one hand, the screwdriver is also held with one hand. Since the front door 100 and the front door frame 120 can be moved with a small force by the principle of leverage, the position of the front door 100 can be easily adjusted even with one hand.

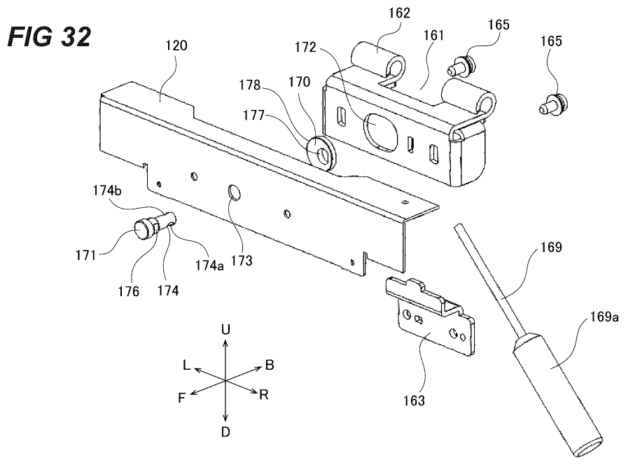

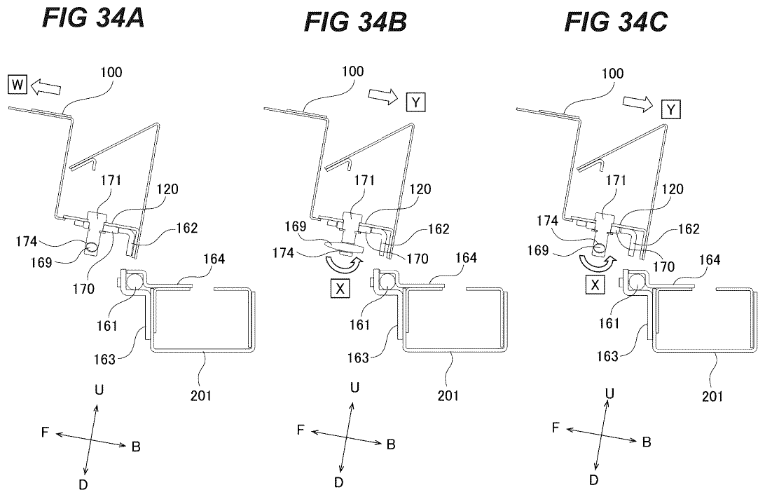

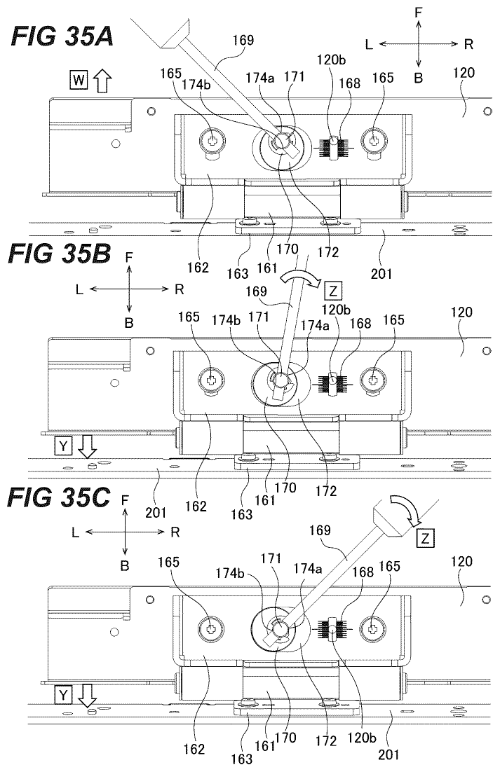

Note that, in the above-described embodiment, it has been exemplified that the adjustment hole 167 serving as an action point when the force for moving the front door 100 is applied to the front door 100 is provided in the front door 100, and the adjustment hole 166 serving as a support point when the force is applied to the front door 100 is provided in the shaft support member 162 to adjust the position of the front door 100. However, the configuration for adjusting the fixed position of the front door 100 is not limited thereto, and for example, the configuration illustrated in FIGS. 32 to 35 may be adopted.

Next, concerning a mechanism for adjusting the fixed position of the front door 100 with respect to the shaft support member 162 of the upper hinge 140, another embodiment will be described with reference to FIGS. 32 to 35C.

As illustrated in FIG. 32, a cam abutment hole 172 is provided in the shaft support member 162. A camshaft attachment hole 173 is provided in the front door frame 120 of the front door. A camshaft 171 is rotatably supported in the camshaft attachment hole 173. A cam 170 is attached to the camshaft 171. That is, the camshaft 171 rotatable about the axis in the front-back direction is disposed on the front door frame 120. An opening (inner edge 177) is provided in the cam 170 to allow the camshaft 171 to be inserted therethrough. Both the outer edge 176 of the camshaft 171 and the inner edge 177 of the cam 170 have a D-cut shape. When the camshaft 171 is inserted through the inner edge 177 of the cam 170, the camshaft 171 and the cam 170 are engaged with each other. That is, the camshaft 171 and the cam 170 are configured to rotate integrally. In other words, the cam 170 that rotates integrally with the camshaft 171 is disposed on the camshaft 171. The cam 170 serving as a cam member has a circular outer edge 178. The center of the circle formed by the outer edge 178 of the cam 170 is shifted from the center of the circular portion of the inner edge 177. The outer edge 178 of the cam 170 is disposed so as to be able to abut on an inner peripheral surface of the cam abutment hole 172 of the shaft support member 162. The cam abutment hole 172 is formed in an elongated hole shape. A width in the up-down direction of the cam abutment hole 172 is substantially equal to a diameter of the outer edge 178 of the cam 170. A width in the left-right direction of the cam abutment hole 172 is sufficiently larger than a diameter of the outer edge 178 of the cam 170. By applying an external force for rotating the cam 170 to the camshaft 171, the cam 170 is rotated integrally with the camshaft 171. This rotation changes the relative position in the left-right direction of the cam 170 with respect to the cam abutment hole 172. On the other hand, since the width in the up-down direction of the cam abutment hole 172 is substantially equal to the diameter of the outer edge 178 of the cam 170, the relative position in the up-down direction between the front door frame 120 and the shaft support member 162 is changed by the rotation of the cam 170. As a result, the front door is moved to a position corresponding to the amount of rotation of the cam 170 with respect to the shaft support member 162.

In addition, a through hole 174 for inserting the shaft member 169 (a hand-held tool, a shaft member attached to the main body of the apparatus, or the like) is formed in an outer peripheral portion of the camshaft 171. The through hole 174 is a through hole provided in the camshaft 171 and penetrating in an intersecting direction intersecting an axial direction of the camshaft 171. In the through hole 174, a first end of the through hole 174 in the intersecting direction functions as an action point when an external force for rotating the cam 170 is applied to the camshaft 171. In the through hole 174, a second end of the through hole 174 opposite to the first end in the intersecting direction functions as a support point when the external force is applied to the camshaft 171. Here, the through hole 174 has a through hole end 174a on an inlet side, into which the shaft member 175 is inserted, as a support point and a through hole end 174b on an outlet side as an action point. Since the support point and the action point are close to each other, a rotational force using the principle of leverage can be applied to the camshaft 171 using the shaft member 169 such as a hand-held tool (or a shaft member attached to the main body of the apparatus).

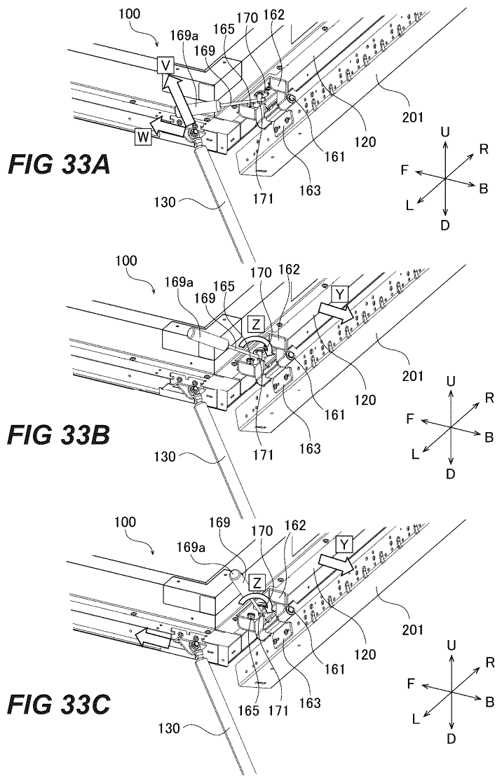

Next, a specific adjustment procedure will be described. As illustrated in FIG. 33A, a force is applied to the front door 100 and the front door frame 120 in the V direction by the gas spring 130. When the fastening of the fastening member 165 is loosened, the front door 100 and the front door frame 120 move in the W direction, because the shaft support member 162 is fixed to the main body frame 200. FIGS. 33A, 34A, and 35A illustrate a state in which the front door 100 and the front door frame 120 have moved in the W direction. In this state, the shaft member 169 is inserted into the through hole 174 of the camshaft 171. As described above, the shaft member 169 may be attached to the main body of the apparatus, or a general tool such as a screwdriver may be used.

Then, the camshaft 171 is rotated in the Z direction using the shaft member 169 inserted into the through hole 174. Here, by using the shaft member 169 inserted into the through hole 174, the external force is applied to the camshaft 171, with the through hole end 174a on the inlet side of the through hole 174 as a support point and the through hole end 174b on the outlet side of the through hole 174 as an action point. At this time, a distance from the force point (the grip portion 169a of the shaft member 169) at which the external force is applied to the shaft member 169 to the support point (the through hole end 174a) is larger than a distance from the support point (the through hole end 174a) to the action point (the through hole end 174b). Therefore, when the shaft member 169 inserted into the through hole 174 is rotated in the Z direction, the force amplified by the principle of leverage is applied to the camshaft 171, and the cam 170 is rotated in the Z direction integrally with the camshaft 171. That is, the force applied to the force point is amplified by the principle of leverage, and the amplified force is applied to the action point. Therefore, even if the force used to operate the shaft member 169 is small, the force amplified by the principle of leverage is applied to the camshaft 171, and the cam 170 is rotated in the Z direction by the amplified force. This rotation changes the abutment position of the cam 170 with respect to the cam abutment hole 172, so that the front door is moved to a position corresponding to the abutment position, making it easy to adjust the position of the front door 100.

As illustrated in FIG. 33B, when the camshaft 171 is rotated in the Z direction using the shaft member 169, the outer edge 178 of the cam 170 rotated integrally with the camshaft 171 abuts on a part of the cam abutment hole 172 of the shaft support member 162. As a result, an abutment force of the cam 170 is applied to the front door 100 and the front door frame 120, and the front door 100 and the front door frame 120 move in the Y direction. FIGS. 33B, 34B, and 35B illustrate a state in the middle of adjustment during which the front door 100 and the front door frame 120 are moving in the Y direction.

As illustrated in FIG. 33C, when the cam 170 is further rotated in the Z direction, the front door 100 and the front door frame 120 further move in the Y direction. Similarly to the above-described embodiment, a scale 168 indicating a standard of a movement amount is engraved on the shaft support member 162, and a mark 120b is provided on the front door frame 120 at a position facing the scale 168 of the shaft support member 162. Therefore, the movement (position adjustment) of the front door 100 can be completed using the scale 168 as a reference. FIGS. 33C, 34C, and 35C illustrate views of the front door 100 and the front door frame 120 in a state where the adjustment is completed. In this embodiment, similarly to the above-described embodiment, the adjustment is performed using scale 0 as a reference, but since the reference changes depending on variations in tolerance of the parts, it is necessary to perform adjustment for each individual part. Since the center of rotation of the cam 170 and the cam abutment portion of the cam abutment hole 172 are close to each other, the applied moment is small, and the phase of the cam 170 is maintained even if the rotation of the cam 170 is stopped midway. Therefore, it is not necessary to hold the shaft member 169 with one hand, and the position of the front door 100 can be easily adjusted.

As described above, the position of the front door can be easily adjusted by performing the adjustment using the principle of leverage. This makes it possible to improve maintainability during factory assembly, installation, and service maintenance.

### Positional Deviation Preventing Configuration of Position Adjustment Mechanism of Front Door

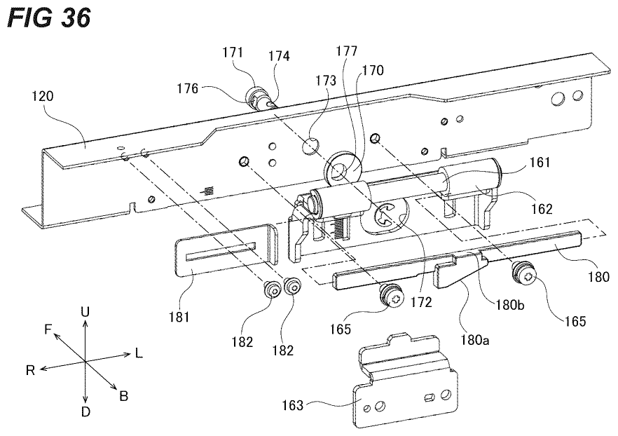

Next, a positional deviation preventing configuration of a position adjustment mechanism of the front door 100 will be described with reference to FIGS. 36 to 40.

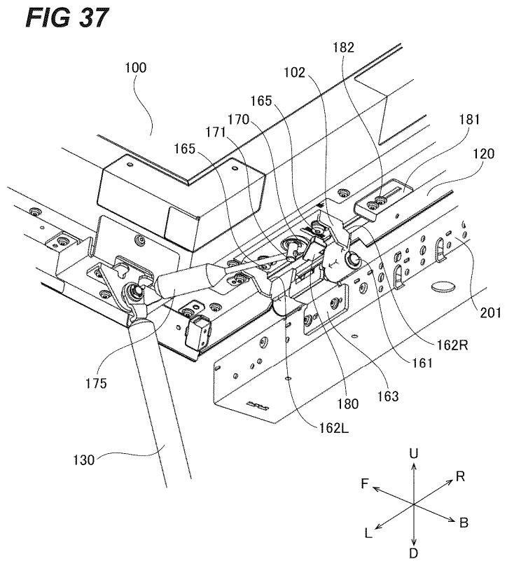

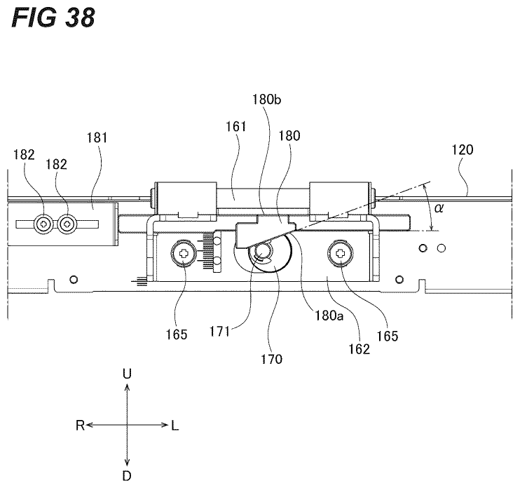

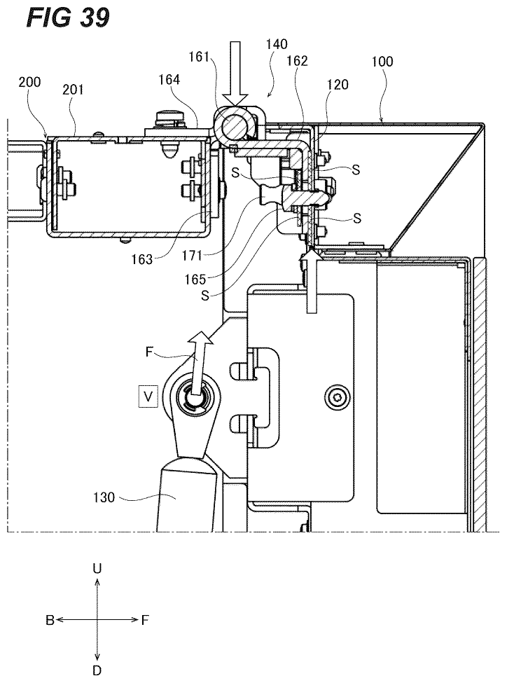

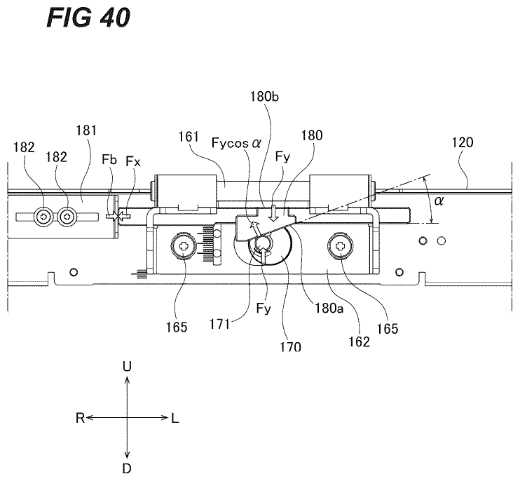

In FIGS. 36 to 40, in addition to the hinge configuration illustrated in FIG. 32, the positional deviation preventing configuration of the position adjustment mechanism is arranged so that the readjustment of the hinge is not required even if an impact occurs due to a drop during physical distribution or the like. FIG. 36 is an exploded perspective view of the position adjustment mechanism having the positional deviation preventing configuration. FIG. 37 is a perspective view of the position adjustment mechanism having the positional deviation preventing configuration during adjustment. FIG. 38 is a front view of the position adjustment mechanism having the positional deviation preventing configuration. FIG. 39 is a cross-sectional view of the periphery of the position adjustment mechanism in a state where the front door is closed. FIG. 40 is a view illustrating a direction of a force applied to the position adjustment mechanism when a drop impact occurs.

As illustrated in FIG. 36, in the present embodiment, a cam stopper 180, a stopper plate 181, and a stopper plate fastening member 182 are added to the configuration illustrated in FIG. 32.

As illustrated in FIGS. 36 and 37, the cam stopper 180 includes an abutment surface 180a that abuts against the camshaft 171, and an abutment surface 180b that is provided on the side opposite to the abutment surface 180a in the vertical direction and abuts against the shaft support member 162. The cam stopper 180 is configured to be slidable in the left-right direction by inserting a right-side portion in the left-right direction of the cam stopper 180 into an opening portion 162R of the shaft support member 162, and inserting a left-side portion in the left-right direction of the cam stopper 180 into an opening portion 162L of the shaft support member 162. The cam stopper 180 is not only supported so as to be slidable in the left-right direction by the opening portions 162R and 162L of the shaft support member 162 but also suppressed from moving in the front-back direction and in the up-down direction intersecting the left-right direction. The stopper plate 181 is restricted from moving in the up-down direction and in the front-back direction by the stopper plate fastening member 182, and is movable in the left-right direction by loosening the fastening of the stopper plate fastening member 182.

FIG. 39 is a cross-sectional view of the upper hinge 140, the front door 100, and the main body frame 200 cut at a portion of the fastening member 165. When the front door 100 is closed, a force F is always applied to the front door 100 in the V direction (substantially vertically upward direction) by a reaction force (e.g., 600 N per piece) of the gas spring 130. Taking into account the weight of the front door 100 (e.g., 300 N), an upward force Fy (e.g., about 450 N) is applied to each of the left and right shaft support members 162 at one location. In order for the front door 100 to always remain at the same position against this force, it is required that a frictional force (e.g., up to about 4500 N, assuming that a static friction coefficient is 0.3) generated at a contact portion s between the shaft support member 162 and the front door frame 120 by a fastening force (up to about 15000 N) of the fastening member 165 be greater than the upward force Fy.

Normally, the frictional force caused by the fastening member 165 is greater than the reaction force of the gas spring 130, so the front door does not deviate.

However, if an impact force (e.g., about 6000 N, assuming that a free fall from about 20 cm is applied to the front door at an impact speed v of 2.0 m/s in 0.01 s) is applied to the front door 100 due to an impact caused by a drop during physical distribution or the like, a load equal to or larger than the frictional force is applied to the contact portion s between the shaft support member 162 and the front door frame 120. Then, the shaft support member 162 can move with respect to the front door frame 120. As a result, there is a possibility that the shaft support member 162 may move to a position different from that in a state adjusted by rotating the cam 170 and the camshaft 171.

That is, if the shaft support member 162 moves with respect to the front door frame 120 due to the impact caused by the physical distribution, the front door 100 may deviate from its position adjusted with respect to the main body frame 200. If the front door deviates, another part may interfere, which may lead to wear or breakage of the part due to contact during vibration. If the front door deviates, the gap between the front door 100 and the surrounding exterior will be uneven, lowering the quality of the exterior. Therefore, it is necessary to prevent the front door frame 120 and the shaft support member 162 from deviating in position from their adjusted states even if there is an impact caused by physical distribution.

Therefore, as illustrated in FIG. 36, the cam stopper 180 is disposed on the shaft support member 162, and the stopper plate 181 and the stopper plate fastening member 182 that restrict a rotation of the cam 170 and a movement of the cam stopper 180 are provided.

The cam stopper 180 is a stopper member including an abutment surface 180a that abuts against the camshaft 171, and movably disposed on the upper hinge 140. The stopper plate 181 and the stopper plate fastening member 182 are movement restricting members disposed on the front door 100 to restrict a movement of the cam stopper 180 that has moved the abutment surface 180a to the position where the abutment surface 180a abuts against the camshaft 171 after the relative position of the front door 100 with respect to the main body frame 200 is adjusted. Hereinafter, this will be described.

As illustrated in FIG. 37, the cam stopper 180 is disposed on the shaft support member 162 such that a right-side portion in the left-right direction is supported by the opening portion 162R on one side in the left-right direction of the shaft support member 162 and a left-side portion in the left-right direction is supported by the opening portion 162L on the other side in the left-right direction of the shaft support member 162.

When adjusting the position of the shaft support member 162 with respect to the front door frame 120 by rotating the cam 170, the stopper plate fastening member 182 is loosened, so that the cam stopper 180 and the stopper plate 181 move to one side in the left-right direction, and are retracted to a position where the rotation of the camshaft 17 is not hindered. Then, the position of the shaft support member 162 is adjusted by rotating the cam 170, and after the position adjustment is completed, the fastening member 165 is tightened to fix the shaft support member 162 to the front door frame 120.

Next, the cam stopper 180 is slid such that the abutment surface 180a of the cam stopper 180 abuts against the camshaft 171 that rotates integrally with the cam 170. The abutment surface 180b of the cam stopper 180 is in contact with the shaft support member 162, and as illustrated in FIGS. 39 and 40, even if an impact caused by physical distribution is applied to the front door 100, a component force in the vertical direction of the impact is applied to the cam stopper 180, which is a rigid body of metal (e.g., AL or SUS), and the shaft support member 162, which is made of iron, as a compressive load.

Note that the relative positions of the camshaft 171 and the shaft support member 162 are changed by rotating the cam 170 during adjustment. Therefore, the abutment surface 180a of the cam stopper 180 is inclined at such an angle α as to abut against the camshaft 171 during adjustment even if the parts vary. The angle α is preferably an angle at which the cam stopper 180 abuts against the camshaft 171 within a movable range in the left-right direction even when the camshaft 171 moves 7 mm in the up-down direction with respect to the shaft support member 162, for example, with the amount of adjustment in the up-down direction by the rotation of the cam 170 being ±3.5 mm. Here, the angle α is an angle formed between the moving direction of the cam stopper 180 and the abutment surface 180a.

FIG. 40 schematically illustrates a direction of a load applied to the camshaft 171 and the cam stopper 180 when a vertical force Fy is applied during drop vibration. The cam stopper 180 receives a force of Fy×cosα from the camshaft 171 in a direction perpendicular to the abutment surface 180a. As described above, the cam stopper 180 does not move in the up-down direction because not only the abutment surface 180a abuts against the camshaft 171, but also the abutment surface 180b opposite to the abutment surface 180a in the up-down direction abuts against the shaft support member 162.

However, the cam stopper 180 receives a component force Fx in the horizontal direction by the angle α of the abutment surface 180a, and therefore, it is necessary to restrict a movement thereof in the horizontal direction. For this reason, after the adjustment is completed by the rotation of the cam 170, the cam stopper 180 is slid in the leftward direction L such that the abutment surface 180a abuts against the camshaft 171, and then the stopper plate 181 is slid in the leftward direction L to abut against the cam stopper 180. By fastening the stopper plate fastening member 182 in this state, the movement of the stopper plate 181 and the cam stopper 180 in the horizontal direction is restricted.

It is desirable that the angle α of the abutment surface 180a of the cam stopper 180 is set such that a stopper plate fastening force Fb of the stopper plate fastening member 182 is smaller than the component force Fx in the horizontal direction, as long as the stroke in the left-right direction of the cam stopper 180 can be ensured. In the present embodiment, the stopper plate 181 is fastened by two stopper plate fastening members 182 (e.g., two screws), and the angle α of the abutment surface 180a is set to 20°. The angle α of the abutment surface 180a is desirably set in a range of 10° to 30° according to the stroke in the left-right direction of the cam stopper 180 and the fastening force Fb of the stopper plate fastening member 182 that prevents the stopper plate 181 from moving.

As described above, in the present embodiment, the cam stopper 180 is provided on the shaft support member 162, and the stopper plate 181 and the stopper plate fastening member 182 that restrict a rotation of the cam 170 and a movement of the cam stopper 180 are provided. By doing so, after the positions of the cam 170 and the shaft support member 162 are adjusted, a rotation of the cam 170 and a movement of the shaft support member 162 are restricted, thereby suppressing the position of the front door 100 from deviating due to an impact caused by physical distribution. This makes it possible to provide an image forming apparatus in which the position of the front door 100 is easily adjusted and the position of the front door 100 does not deviate due to an impact caused by physical distribution. In addition, it is possible to provide an image forming apparatus that can be installed in a shorter time and maintains the quality of its exterior well.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-167006, filed Sep. 26, 2024, No. 2025-068691, filed Apr. 18, 2025, which is hereby incorporated by reference herein in its entirety.

1. An image forming apparatus comprising:
an image forming portion configured to form an image on a sheet;
a main body frame supporting the image forming portion;
a door disposed on a front side of the image forming portion in a front-back direction intersecting a vertical direction, and attached to the main body frame to form at least part of a front exterior; and
a hinge connecting the door and the main body frame such that the door rotates to be opened and closed with respect to the main body frame,
wherein an adjustment hole is provided in each of the door and the hinge, and
the adjustment hole of the door and the adjustment hole of the hinge are arranged to at least partially overlap each other.

2. The image forming apparatus according to claim 1, wherein
the hinge includes:
a first shaft support member attached to the main body frame;
a second shaft support member attached to the door; and
a shaft member supported by the first shaft support member and the second shaft support member,
the door is opened and closed by rotating about the shaft member,
the adjustment hole of the hinge is provided in the second shaft support member, and
the adjustment hole of the door and the adjustment hole of the second shaft support member are arranged to at least partially overlap each other.

3. The image forming apparatus according to claim 2, wherein, when an external force for moving the door connected to the hinge is applied to the door by an insertion member inserted into the adjustment hole of the door and the adjustment hole of the second shaft support member, the adjustment hole provided in the second shaft support member functions as a support point, and the adjustment hole provided in the door functions as an action point.

4. The image forming apparatus according to claim 3, wherein a distance from a force point at which the external force is applied to the insertion member to the support point is greater than a distance from the support point to the action point.

5. The image forming apparatus according to claim 1, further comprising:
an auxiliary member configured to assist the rotation of the door,
wherein the auxiliary member applies a force to the door in an opening direction with respect to the main body frame.

6. The image forming apparatus according to claim 2, wherein the door includes a frame member and an exterior cover, and the second shaft support member is attached to the frame member.

7. An image forming apparatus comprising:
an image forming portion configured to form an image on a sheet;
a main body frame supporting the image forming portion;
a door disposed on a front side of the image forming portion in a front-back direction intersecting a vertical direction, and attached to the main body frame to form an exterior of a front surface;
a hinge connecting the door and the main body frame such that the door is opened and closed with respect to the main body frame as the door is rotated;
a camshaft attached into an attachment hole provided in the door; and
a cam member disposed in an abutment hole provided in the hinge, and configured to rotate integrally with the camshaft,
wherein relative positions of the main body frame and the hinge change according to an amount of the rotation of the cam member.

8. The image forming apparatus according to claim 7, wherein
the hinge includes:
a first shaft support member attached to the main body frame;
a second shaft support member attached to the door; and
a shaft member supported by the first shaft support member and the second shaft support member,
the door is opened and closed by rotating about the shaft member, and
the abutment hole is provided in the second shaft support member.

9. The image forming apparatus according to claim 7, wherein
the camshaft has a through hole penetrating in an intersecting direction intersecting an axial direction of the camshaft,
a first end in the intersecting direction of the through hole functions as an action point when an external force for rotating the cam member is applied to the camshaft, and
a second end of the through hole opposite to the first end in the intersecting direction functions as a support point when the external force is applied to the camshaft.

10. The image forming apparatus according to claim 9, wherein the external force is applied to the camshaft by an insertion member inserted into the through hole, so that the cam member rotates, and the relative positions of the main body frame and the hinge are adjusted by the rotation.

11. The image forming apparatus according to claim 10, wherein a distance from a force point at which the external force is applied to the insertion member to the support point is greater than a distance from the support point to the action point.

12. The image forming apparatus according to claim 7, further comprising:
an auxiliary member configured to assist the rotation of the door,
wherein the auxiliary member applies a force to the door in an opening direction with respect to the main body frame.

13. The image forming apparatus according to claim 8, wherein the door includes a frame member and an exterior cover, and the second shaft support member is attached to the frame member.

14. The image forming apparatus according to claim 7, further comprising:
a stopper member including an abutment surface that abuts against the camshaft, the stopper member being movably disposed on the hinge; and
a movement restricting member disposed on the door to restrict a movement of the stopper member moved to a position where the abutment surface abuts against the camshaft after the relative positions are adjusted.
